(19) United States
(12) Patent Application Publication
(10) Pub. No.: US 2002/0111787 A1
(43) Pub. Date: Aug. 15, 2002

(54) Client-driven workload environment

(76) Inventors: Iko Knyphausen, Lake Forest Park, WA (US); Hummel Jochen, Alexandria, VA (US)

Correspondence Address: BANNER & WITCOFF, 1001 G STREET N W, SUITE 1100, WASHINGTON, DC, 20001, US

(21) Appl. No.: 09/975,084

(22) Filed: Oct. 12, 2001

Related U.S. Application Data
(60) Provisional application No. 60/239,929, filed on Oct. 13, 2000.

(51) Int. Cl. G06F 17/28

(52) U.S. Cl. 704/2

(57) ABSTRACT

A system and method for coordinating workflow among resources from a central client is disclosed. A program manager designates projects and assigns resources to complete the projects. The resources download the projects, complete the projects, and upload them for final approval by the program manager. The resources may include translators, editors, printers, quality control, and legal counsel.

### RELATED APPLICATIONS

This application claims priority to U.S. Provisional Application Serial No. 60/239,929, entitled “Client-Driven Workflow Management,” filed on Oct. 13, 2000, whose contents are incorporated by reference.

This application is also related to U.S. Ser. No. 09/071,900, filed May 4, 1998, entitled “Machine-Assisted Translation Tools”, and U.S. Ser. Nos. 09/303,499 and 09/317,979, filed Apr. 30, 1999, and May 25, 1999, respectively, both entitled “Workflow Management System”, whose contents are incorporated by reference for any essential subject matter.

### BACKGROUND OF INVENTION

With the growth of electronic commerce paralleling the number of users having access to the World Wide Web, vendors are becoming increasingly aware of the internationalism of the Internet. While English used to be the language of electronic commerce (or e-commerce) as most vendors and customers spoke English as their native tongue, other languages are now common on the Internet as access spreads to non-native English speaking peoples.

Vendors will eventually want to sell their goods and services to people of all languages. Accordingly, the need for translations will increase. Large, international vendors generate significant volumes of documents per year. Often, the documents are created in a first language then translated into other languages. The demand for faster translations grows as the quantity of documents from the translators increases. However, the world's number of translators is relatively fixed, thereby creating a high cost per translation. Because of the volume of material to be translated, translators become backed up with pending work and throughput suffers. Accordingly, a system is needed to manage workflow for translators.

Machine translation is becoming popular. However, those of skill in the art recognize that truly accurate translations require a human to translate and review the finished work to be sure that the translated document accurately reflects the original source document.

Translation memories are used by translators. Translation memories store pairs of sentences, from a source language into a target language. When a translator encounters a sentence in a source document that matches a first sentence of the sentence pair, the translator may adopt the second sentence in the target language. With the translation of the first sentence into the second sentence being considered as an accepted translation, the job of the translator is made easier in that he may concentrate his translation efforts on sentences lacking a known translation. Any new translation results in a new sentence pair, which is then uploaded and forms part of the expanding translation memory. A workflow system using translation memories is disclosed in related application Ser. No. 09/303,499, filed Apr. 30, 1999.

Despite the advantages of large and dynamic translation memories, some vendors (also referred to herein as clients) consider their source and target documents as sensitive not only for the content, but also to the way the source document was translated. Thus, some clients refrain from using the above-identified system. Accordingly, a workflow system is needed that provides the advantages of translation memories and protects the confidences of the clients. Further, a workflow system is needed that mirrors the different projects undertaken by each unique client for both translation-based and non-translation based workflow models. The workflow system needs to accommodate the various processes of each client. SUMMARY

The present invention provides a client-based workflow system that permits the client to assign and monitor various tasks. The client includes a project manager who assigns a project to a variety of resources. The resources may include document creators, translators, editors, legal counsel (for legal review of documents), printers, quality control and the like.

Through the use of selectable templates, the client may choose from different workflow models for different projects. For example, a first template may include a translator and editor. A second template may include a translator, an editor, legal counsel, printer, quality control, and the like. The template may be defined for each client or each client may develop new templates as desired.

The system also provides a user interface for monitoring the progress of projects as including a status monitoring system as well as monitoring the progress of the projects with different levels of granularity.

To assist with project assignments, the system provides an estimating feature that permits a project manager to estimate the length of a project based on a variety of criteria including analysis of a document to be translated including the length of the document, the percentage of translation memories that may be applied to the document to translate it from a source language into a target language, an analysis of each translator's specific throughput and quality, an analysis of internal repetition of segments contained within the document, the specific template used, the technology of the subject matter, a statistical analysis on a percentage basis of similarity of segments in the source document to segments in the translation memory, and the number of languages into which the source document needs to be translated. Further, the estimation process may include estimating the project using different levels of granularity. So, for a simple translation of a small document from English to German with no immediate due date, a project manager may use an estimate comprising of the size of the document and a predefined translation rate for a generic English to German translator. For a more complex document specifying a help file for diagnosing and repairing telecommunications equipment to be translated from English to Japanese within a short time frame, for example, a project manager may include in the estimate the quality and throughput of each translator and editor involved, the subject matter of the document, the numbers of technical and legal reviewers, and the like.

Further, the system includes a monitoring aspect that adapts the workflow process to account for interrupts or new uploads of source documents. Here, for example, if a project manager uploads a new page 3 of a seven page document, the system may stop a translator from completing her current work on the document and switch her to the revised document. Alternatively, depending on where the translator is in the translating process, the system may permit the translator to continue translating. By permitting the translator to continue translating, the recaptured translation memories may be applied to the revised source document when later downloaded to the translator. An advantage of this latter approach focuses the attention of the translator to the new page 3 (as the remaining pages 1-2 and 4-7 would have already been translated and new translation memory pairs captured from the completed, original source and target documents and applied to the revised source document).

For a client-centered workflow system, a client releases a project to start the resources working on the project. In releasing the project, a client posts the source document with a set of suggested translation memory pairs to a location from which the resources (or at least the first round of resources) may access the source document. Alternatively, the client may send the documents to the resources. In a translation environment, the document may include a suggested set of translation memories. The memories may be general or may be specific to the area of technology or business of the source document. Also, the translation memories may be drawn from the client's proprietary memories, not a general memory. Once the translation is complete, the target document is uploaded with any new translation memory pairs created during the translation process.

In an alternative embodiment, translation memories may also be drawn from a general repository of translation memories in addition to the translation memories of the client. Accordingly, the translation memories used by the translator may be a combination of the translation memories from the client and the general repository. The translation memory suggestions drawn from the general repository may relate to all text of the source document, may relate to only the text of the source document lacking matches in the client's translation memory repository, and may relate to only the text of the source document in which the client's translation memory did not provide a suggested translation above a threshold percentage (for example, 80%).

Further, using the disclosed system, a translator working for different clients may receive different proposed translations for the same sentence. In other words, the same sentence may have different preferred translations based on the client's preferences or previously performed translation.

These and other benefits will be come apparent as described in the following drawings and detailed description of the invention.

### BRIEF DESCRIPTION OF DRAWINGS

FIG. 1A-1G show various processes shown by embodiments of the present invention.

FIG. 2 shows an example of a project model in accordance with embodiments of the present invention.

FIG. 3 shows archival, abortion, and deletion processes in accordance with embodiments of the present invention.

FIG. 4 shows an interface for receiving information from a project manager for creating a new project in accordance with embodiments of the present invention.

FIG. 5 shows another interface for a project manager for defining subprojects in accordance with embodiments of the present invention.

FIGS. 6, 11, 12, 13, and 14 show various task lists for a program manager in accordance with embodiments of the present invention.

FIG. 7 shows a list of source files to be uploaded by a program manager in accordance with embodiments of the present invention.

FIG. 8 shows the selection of a translation memory in accordance with embodiments of the present invention.

FIG. 9 shows the results of analyzing a document in accordance with embodiments of the present invention.

FIG. 10 shows resources matching search criteria in accordance with embodiments of the present invention.

FIG. 15 shows a status report of a number of subprojects in accordance with embodiments of the present invention.

FIG. 16 shows multiple translators working on a project in accordance with embodiments of the present invention.

FIG. 17 shows the current assignment and progress of a resource in accordance with embodiments of the present invention.

FIG. 18 shows the status of subprojects with their current assignments in accordance with embodiments of the present invention.

FIG. 19 shows the result of a project manager un-assigning a resource in accordance with embodiments of the present invention.

FIG. 20 shows a process for assigning resources in accordance with embodiments of the present invention.

FIG. 21 shows a task list for a translator in accordance with embodiments of the present invention.

FIG. 22 shows source files available for a resource to download in accordance with embodiments of the present invention.

FIGS. 23 and 24 show reference materials available for a resource to download in accordance with embodiments of the present invention.

FIG. 25 shows a translation memory available for a resource to download in accordance with embodiments of the present invention.

FIG. 26 shows a task list for a resource in accordance with embodiments of the present invention.

FIG. 27 shows an assignment confirmation form available for a resource in accordance with embodiments of the present invention.

FIGS. 28-30 show communications interfaces in accordance with embodiments of the present invention.

FIG. 31 shows a document exchange interface for a resource in accordance with embodiments of the present invention.

FIG. 32 shows a translator's translation interface in accordance with embodiments of the present invention.

FIG. 33 shows communication pathways between entities in accordance with embodiments of the present invention.

FIG. 34 shows a status list for another resource in accordance with embodiments of the present invention.

FIG. 35 shows a task list for another resource in accordance with embodiments of the present invention.

FIG. 36 shows an approval interface for a project manager in accordance with embodiments of the present invention.

FIG. 37 shows an alert sent to a resource if a file has not been processed properly in accordance with embodiments of the present invention.

FIG. 38 shows a troubleshooting process in accordance with embodiments of the present invention.

FIG. 39 shows a troubleshooter assignment interface for a program manager in accordance with embodiments of the present invention.

### DETAILED DESCRIPTION

The invention relates to an improved workflow system that provides benefits to clients as well as streamlines operations for resources. The invention includes user interfaces, processes, computer systems, and computer-readable mediums having programs stored thereon. While some processes may be described as occurring in software, it is appreciated that one of ordinary skill in the art may implement the processes in hardware to improve processing speed. The software associated with the invention may be programmed in C, C++, Visual Basic, and any other related high order programming language. Further, the user interfaces may incorporate various mark-up languages to ease programming requirements. The system may be implemented on a stand-alone computer, on a computer connected to a network, on a number of computers connected to a network, and/or on a number of computers connected to the internet and other networks.

The invention permits clients to enhance their current steps used to produce finished products. Instead of forcing clients to adopt a single generic workflow process, the system includes templates that may be used to more adequately model how the particular client produces projects. The templates include a series of steps with various reporting flags to report when a resource has downloaded a project, the status of the resource in completing the project, and other information useful to a program manager. The templates have basic modules that may be added together for embody a current client's workflow process. The modules may include a document creator, a translator, an editor, legal counsel or other type of reviewing systems, localization resources (to provide a local look and feel to a project document), printing and quality control systems, and the like. The system may be integrated with third party technology in various industry categories including content management, e-support, ECRM, global exchanges, ERP systems,

The program manager, resources, and client repository include computers capable of uploading and downloading information over the Internet or other network of computers. A standard computer useable by a program manager includes a Pentium III with 64 M of RAM and 4 GB hard drive with modem or other network connection. In other embodiments of the present invention, the program manager, resources and client repository may in part, or in whole, be resident on a sole computer. Thus, a translator, for example, may receive a project, subdivide the project into tasks, then accomplish the tasks in due course, from the computer.

The templates permit a program manager to track various items including the downloading of source documents, reference documents, and translation memories. Also, the templates permit a program manager to monitor the assignment of resources to various projects as well as the status of the resources in completing the subprojects constituting each project assigned to each resource. Finally, in the document translation realm, the templates permit a program manager to monitor the recollected translation memory pairs as created through the translation of a source document into a target document.

The invention may be applied to a variety of areas including the translation of documents, posting and translating material for auctions and bidding systems, transmitting bills and receiving payments for billing and related financial systems, and the like.

The description of the invention is organized to show process flows as taken by the project managers and resources followed by various user interfaces embodying the process flows.

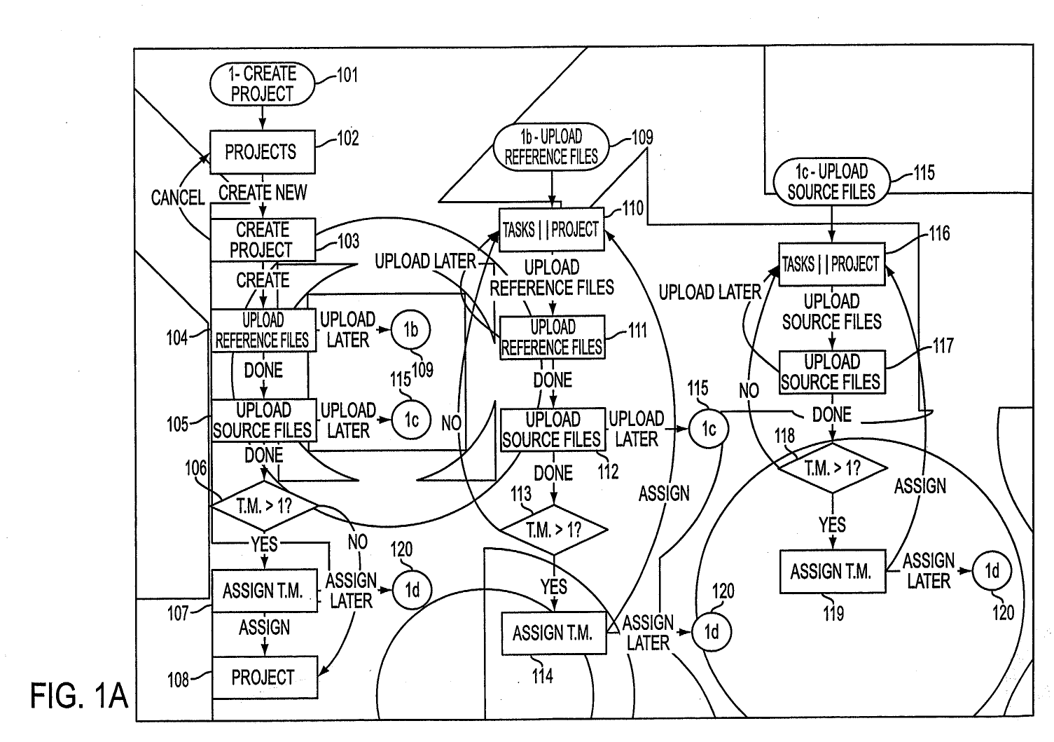

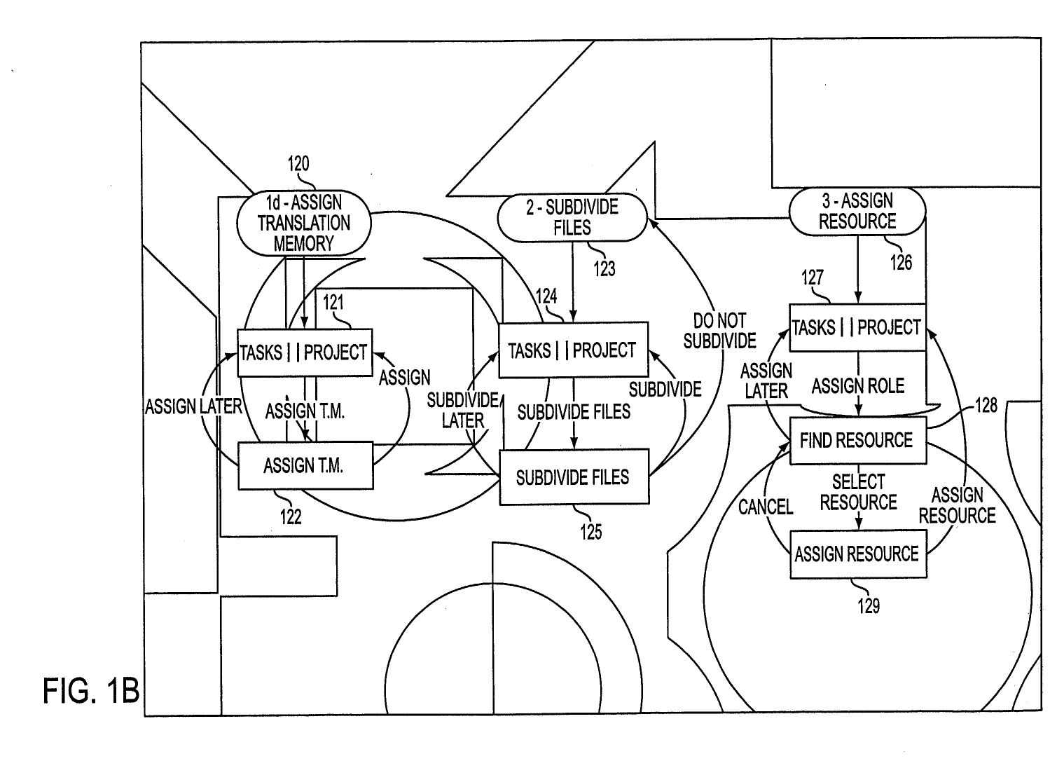

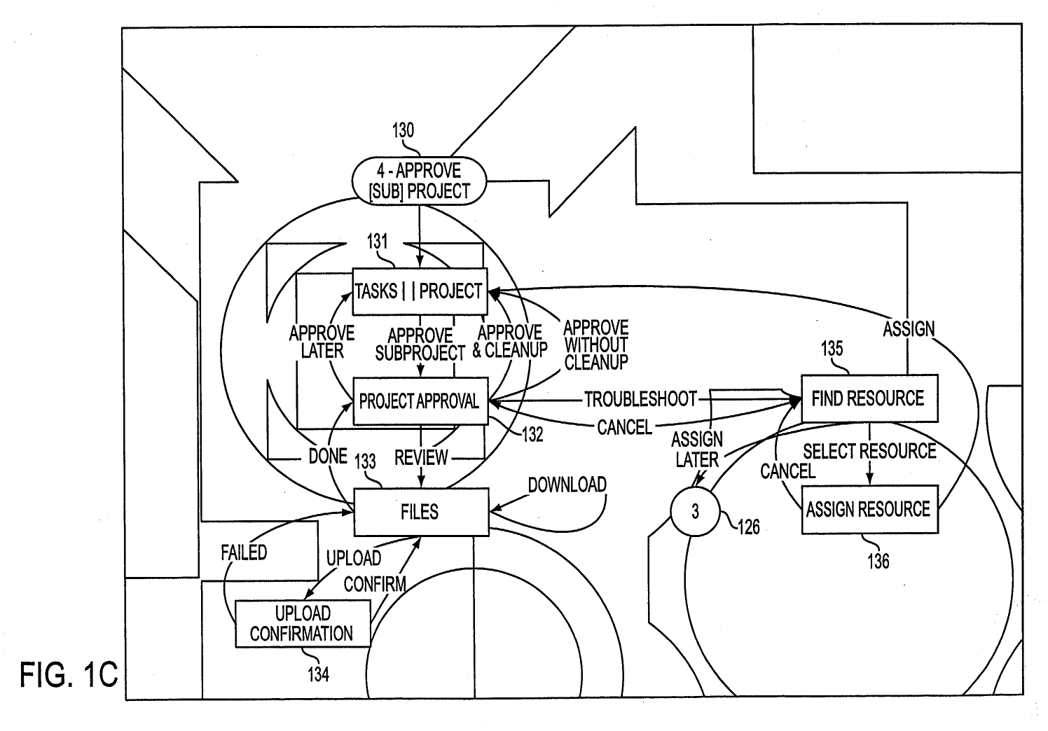

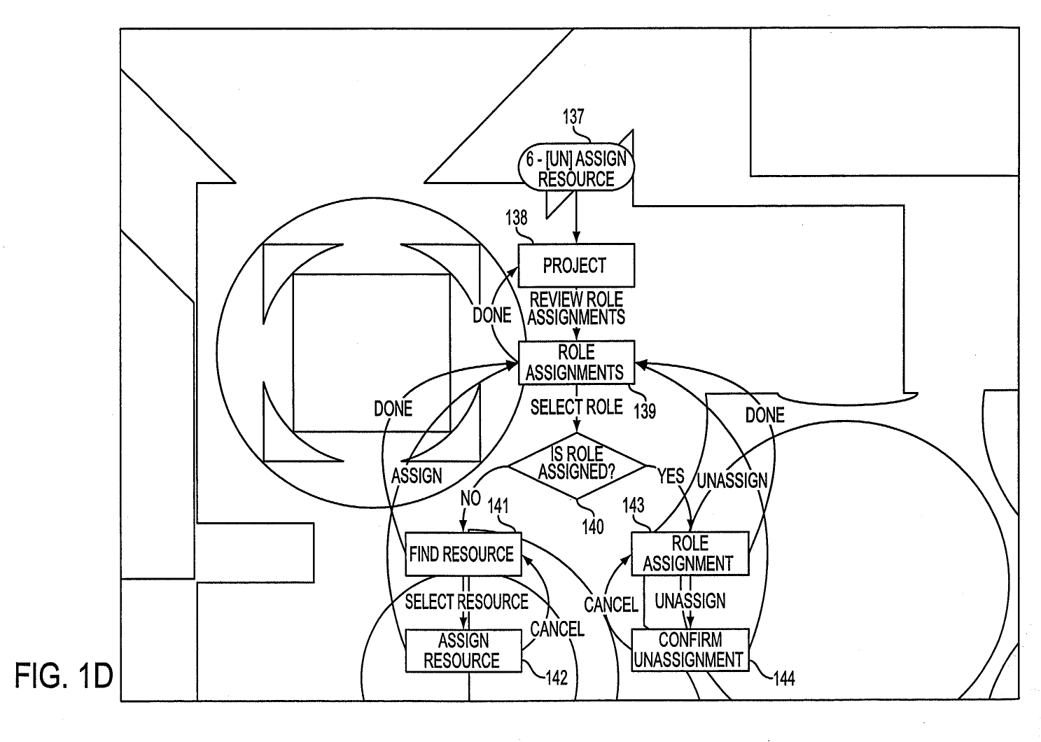

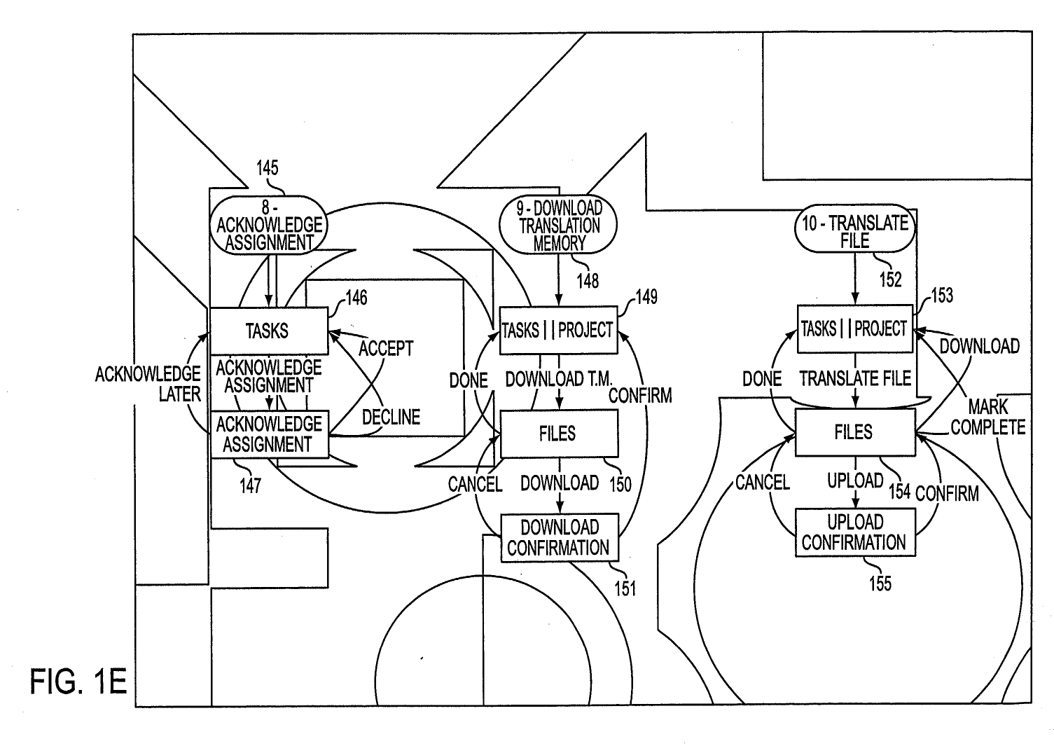

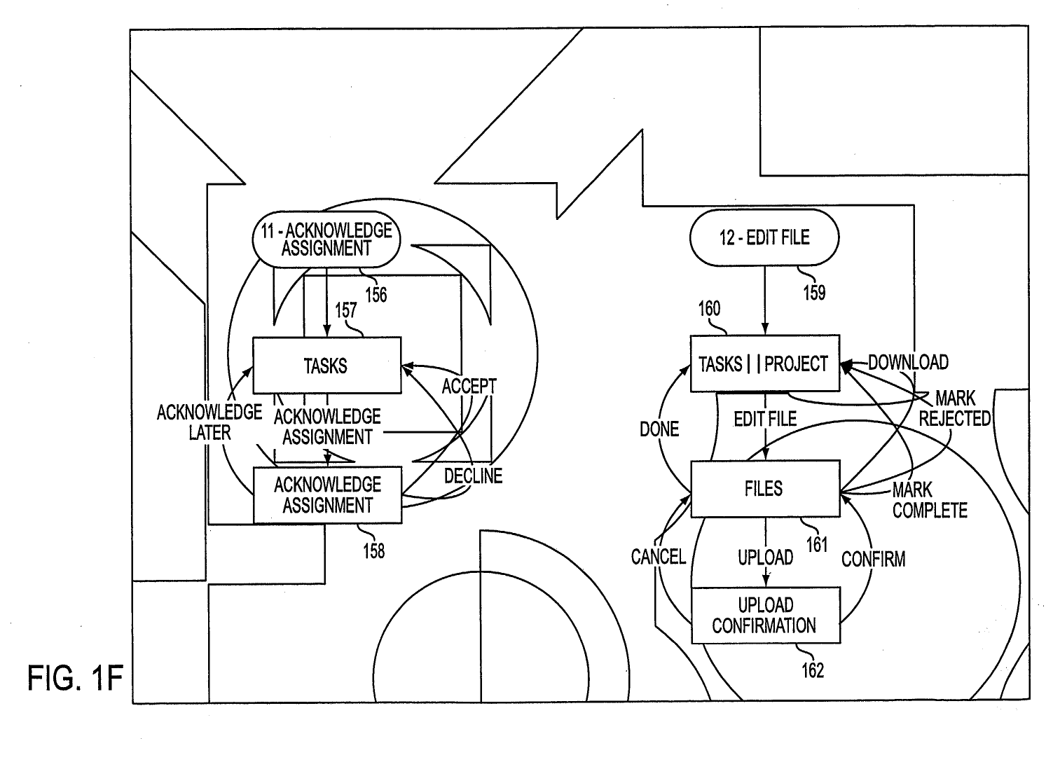

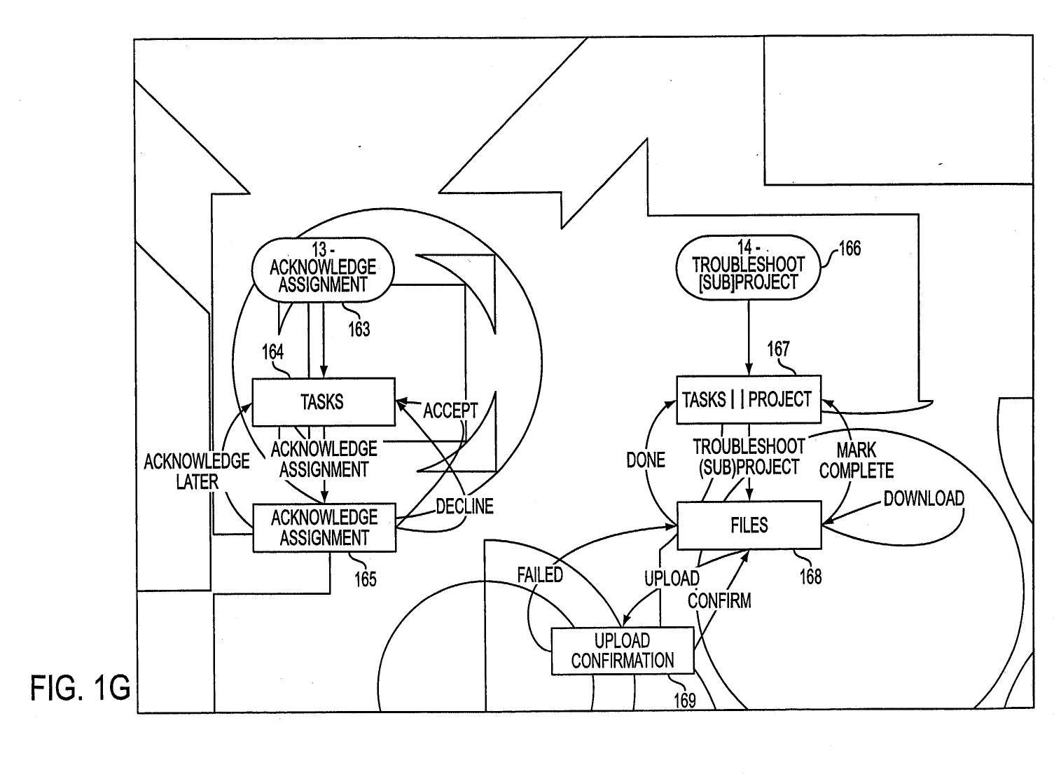

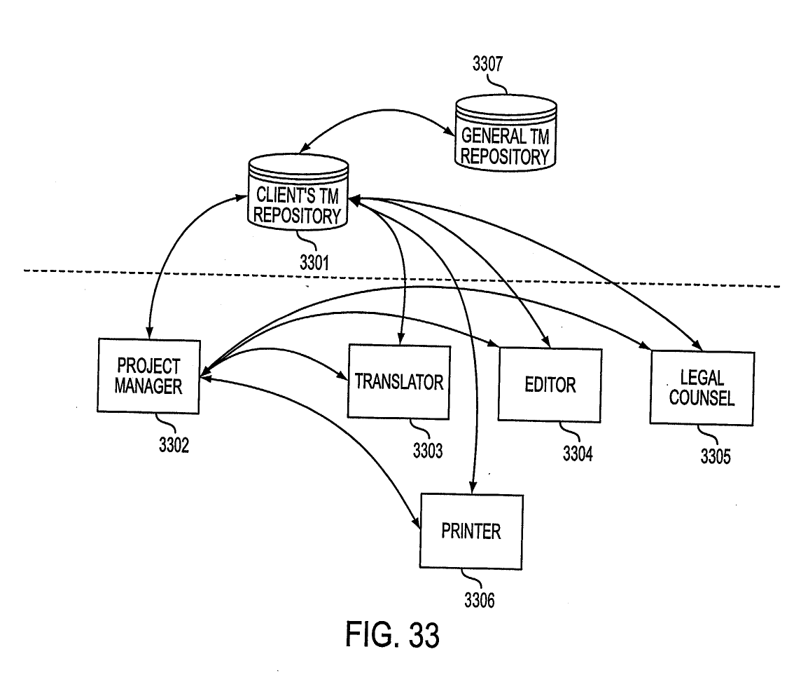

To create a project, a project manager (for example, 3302 in FIG. 33) uses the system to specify a new project. FIG. 1A shows a process by which the program manager starts the creation process 101. While described here as a user interface, it is appreciated that alternative systems may be used. First, the program manager navigates the system to a projects page 102 where the user selects a new project. If the project manager made a mistake or wishes to perform another action, the project manager may cancel and return his focus to the projects page 102. Once on the create projects page 103, the program manager uploads reference files 104 (or may upload them later in step 109, which may be done through selecting an upload later option in a user interface). It is appreciated that the reference files (files that help a translator in terms of style, provide instructions, or a glossary) may only need to be uploaded once as the program manager may re-designate the previously uploaded files for a new project. Once this has been done, the program manager uploads source files in step 105. Alternatively, the source files may be uploaded later in step 115.

The following relates to a translation workflow process. It is appreciated that nontranslation workflows may use the same workflow engine for similar benefits as described above. Next, the system checks in step 106 whether more than one set of translation memories are resident in the client's repository (for example, repository 3301 of FIG. 33). If more than one set of translation memories are present, the program manager is prompted to assign in step 107 the specific translation memory that will be used. Alternatively, the program manager may assign the translation memories at a later time (in step 120). If only one set of translation memories are present, the system may skip directly to step 108.

Finally, the program manager assigns the project to resources in step 108.

If the program manager decides to upload the reference files at a later time, the program manager is prompted to do so by a tasks list and is eventually directed to process step 109 where the reference files are to be uploaded. Starting either from a tasks view or project view 110, the program manager starts to upload reference files 111. Once done, the program manager is prompted to upload source files in step 112, if not already completed. Again the program manager may delay uploading the source files as shown by step 115. If uploaded, the system checks the translation memories and waits for program manager assignment in step 114, similar to that shown in steps 106 and 107.

Once the translation memory has been assigned, the program manager returns to the task/project view of the system 110.

Finally, if the program manager uploads the source files later (step 115), he is eventually directed to the task/project view 116 of the system. Next, the program manager uploads the source files in step 117. While the program manager may again select to upload the source files at a later time, the system may continue to prompt the program manager to upload the source files by returning to tasks/project view 116. Once the source files have been uploaded, the system assigns the translation memories in steps 118, 119, or 120, which are similar to those steps shown by steps 106, 107, 113, and 114.

Referring to FIG. 1B, the program manager is directed to assign the translation memory to be used for finding a suggested translation in step 120. It is noted that a program manager may not need to assign a specific translation memory if only one translation memory exists in the repository 3301. From the tasks/project view 121, the program manager assigns the translation memories in step 122. If the memory was assigned or the program manager decides to assign the memory later, the system steps back to the tasks/program view 121.

The next process in preparing project is subdividing the project in to subprojects. In that the project may be based on a variety of files, one may refer to subdividing the project as simply subdividing the files that make up the project (step 123). Referring to FIG. 1B, from the tasks/project view 124, the system prompts the program manager to subdivide the project files in step 125. The program manager may choose to subdivide later, subdivide the files now, or not to subdivide the project. Each of the options of subdividing the files and subdividing later returns the program manager to the tasks/project view 124. If the program manager decides not to subdivide, the program manager is later prompted to subdivide by returning to step 123.

The next step in preparing the project is to assign resources to the project in step 126. From the tasks/projects view 127, the program manager attempts to find a resource in step 128. Once resources are found, the program manager assigns the resource or resources in step 129. If no resources match the needs of the program manager, the program manager returns to step 128 to attempt to find a new resource. This may include changing search criteria used for locating the resources.

The resources are then set to work on the project (treated in greater detail with respect to FIGS. 1E, 1F, and 1G.

Next, once work has been completed on the subproject by the resources, the program manager approves the subproject as returned from the resources in step 130. From the tasks/project view 131, the program manager indicates he wants to approve the subproject and moves to step 132 for project approval. In step 133, the program manager downloads any completed files and review files. If modifications need to be made or the program manager wants to release the resource from the work, the program manager uploads this information and confirms the upload in step 134. If not, the program manager again may attempt to upload the files or status report.

Once back at the project approval step 132, the program manager may approve the project without cleanup required, may approve the project with cleanup necessary (and request the resource to clean up the files as needed), or may delay approval for a later time.

If an error has occurred with the files from the resource, the program manager may start to troubleshoot the error or ask that a resource troubleshoot the error. If a resource is to troubleshoot the error, the system proceeds to find a resource in step 135. If a resource is available, the program manager may assign this resource to troubleshoot the error in step 136. Alternatively, the program manager may elect to assign the resource at a later time (step 126).

The program manager may want to unassign or reassign a resource. FIG. 1d shows the process 137 for unassigning a resource. From a project view 138, the program manager reviews the role assignments in step 139. The program manager may select a role for a project (for example, translator, editor, and the like). If no role has been assigned, the program manager may assign a resource in steps 141 and 142, similar to that of steps 128 and 129. If a resource has been assigned, as determined in step 140, the program manager reviews the role assignment in step 143 and selects to unassign the current resource from a task. The system then asks the program manager for confirmation of the unassignment in step 144. Next, the system returns to the role assignments step 139 for receiving assignments to the newly unassigned task or task.

FIG. 1E reflects the processes undertaken by a resource. For example, the resource shown in FIG. 1E is a translator. Other resources may benefit from the same process flows. First, in response to an assignment from a program manager, the resource needs to acknowledge the assignment to a task 145. From a tasks view 146, the resource acknowledges the assignment in step 147. The resource may review the assignment prior to accepting it. Reviewing the assignment may include reviewing files associated with the tasks or subproject, reviewing the amount of time needed to complete the work, evaluating time constraints of other pending items, evaluating the translator's own efficiency, evaluating the source and target languages (for translation purposes), evaluating the percentage of and quality of translation memory matches, and evaluating the subject matter. To ensure that a project or subproject is not held up but the lack of acknowledgement by a resource, watchdog timers may be used to provide a window during which a resource may respond to an assignment. If the resource does not respond to the assignment during the window, the assignment may be resent or revoked.

Once accepting the project, the resource needs to download the assignment and related material (step 148). From the tasks/project view, a resource starts to download the project materials. Here, a translator downloads a translation memory designated in 107, 114, 119, or 122. Alternatively, the translator only downloads the suggested translation memory pairs that have been previously compared against the source files. Using this alternative approach, the translator does not need to download unneeded portions of the repository 3301's translation memory. This may also include the step of downloading reference material. The reference material may be helpful in guiding the resource in performing its function. Next, in step 150, the translator downloads the files to be translated. Once downloaded, the translator may confirm the download to ensure that all appropriate files have been received and received properly. Alternatively, the translator may not confirm the download as the expectation from the program manager is that the resource is obligated to alert the program manager if there are any difficulties. This alternative approach minimizes messages that need to be transferred to the program manager or system. Further, the download confirmation may be integrated into the file download process (HTTP, FTP) so as to alert any of the resource or the system if there is an error in downloading.

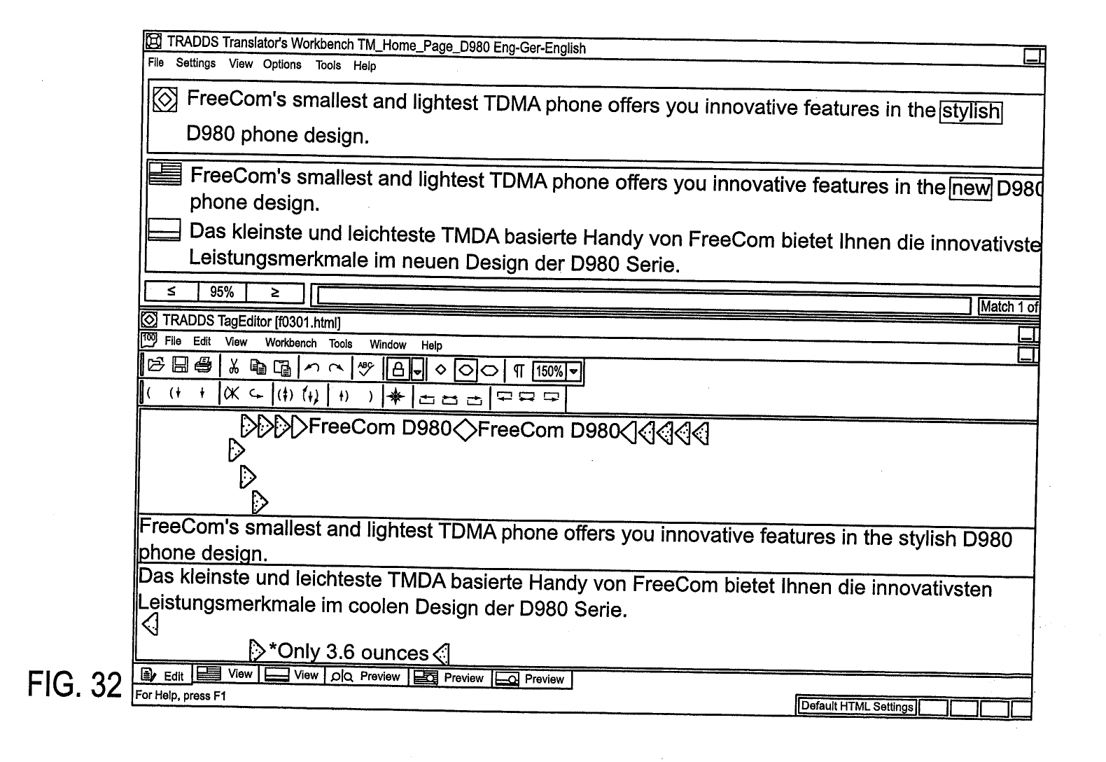

Next, the resource works on the file. Here, a translator starts to translate the file 152. From the tasks/project view 153, the translator begins to translate the source document or documents. The translating system may be a graphical interface system using the downloaded portions of the translation memories. An example of a translation system includes the Trados Corporation's Workbench translation software and as shown in FIG. 32.

As shown in step 154, during translation or after translation, the translator may download replacement or additional files. In the case of replacement files, a situation may occur where a project manager has updated the source files after the translator (or other resource started work on the files). For example, if a project manager uploads a new page 3 of a seven page document (or a new file number three of a seven file project), the system may stop a translator from completing her current work on the document and switch her to the revised document. This may be accomplished by sending a communication (an email notice to stop work, for example). Alternatively, depending on where the translator is in the translating process, the system may permit the translator to continue translating. By permitting the translator to continue translating, the recaptured translation memories may be applied to the revised source document when later downloaded to the translator. An advantage of this latter approach focuses the attention of the translator to the new page 3 (as the remaining pages 1-2 and 4-7 would have already been translated and new translation memory pairs captured from the completed, original source and target documents and applied to the revised source document).

Once a translator is done with the files, the translator uploads the files to the system and the system confirms that they have been successfully uploaded in step 155. Further, the translator may mark the files as complete in step 154. Uploading files to the system provides the advantage of keeping the files in a secure location (apart from local storage crashes of the resources) as well as provides a status update to the system, indicating where the resource is in the project. Further, if changes need to be made (for example, a translator develops an improved way of translating a difficult phrase or concept), the resource may revise the remotely stored file prior to marking the project as complete. Alternatively, the resource may store the completed files locally and upload them together with the uploading of all files constituting an indication that the tasks assigned to the resource have been completed.

FIG. 1F shows another resource's process for acknowledging an assignment and performing its task. Here, the resource may be an editor that edits the translation provided by a translator. In response to an assignment from a program manager, the resource needs to acknowledge the assignment to a task 156. From a tasks view 157, the resource acknowledges the assignment in step 158. The resource may review the assignment prior to accepting it. Reviewing the assignment may include (for an editor) reviewing the translator's profile, reviewing previous work submitted by the translator, reviewing the amount of time needed to complete the work, evaluating time constraints of other pending items, evaluating the editor's own efficiency, evaluating the source and target languages (for editing a translation), evaluating the percentage of and quality of translation memory matches, and evaluating the subject matter.

After accepting an assignment, the resource may start working on the assignment once all materials have been received. In this example, the editor needs to receive the translated document from an upstream translator. While both the translator and the editor may be assigned at the same time or provide acceptance of assignments at the same time, the roles of resources may dictate when one may begin work based on the previous work of another.

From tasks/project view 160, the editor begins editing the file received (directly or indirectly) from the translator (reflected by the download arrow off the files step 161). After editing, the resulting file (at step 161) may be rejected by the editor. The translator would then correct the translation problems noted by the editor. The resulting file (at step 161) may be approved by the editor and uploaded to the system in step 162 where the upload is confirmed. Finally, the file may be marked as complete and this information passed back to the system. This may involve a status indicator being sent to the project manager for showing the status of the editor.

Finally, referring to FIG. 1G, a troubleshooter may be assigned to address any problems in an uploaded file. FIG. 1C reflects the process from the program manager's view of assigning a troubleshooter. FIG. IG reflects the process from the troubleshooter's view 163. From a task view 164, a troubleshooter 164 is assigned to a project by a program manager. In step 165, the troubleshooter acknowledges the assignment either by accepting or declining the assignment. Further, the troubleshooter may postpone acknowledgement for a later time or may review a troublesome file prior to accepting an assignment. Once accepting the assignment, the troubleshooter may start to work on the problem files once received (step 166). From the tasks/project menu 167, the troubleshooter accesses a files interface 168 where the troubleshooter may download the problem files (or sub projects) and start fixing them as needed as referenced in step 168. Once complete, the troubleshooter may upload the files with a confirmation from the system as shown in step 169. Finally, the troubleshooter may mark the uploaded files complete and finish the troubleshooting project.

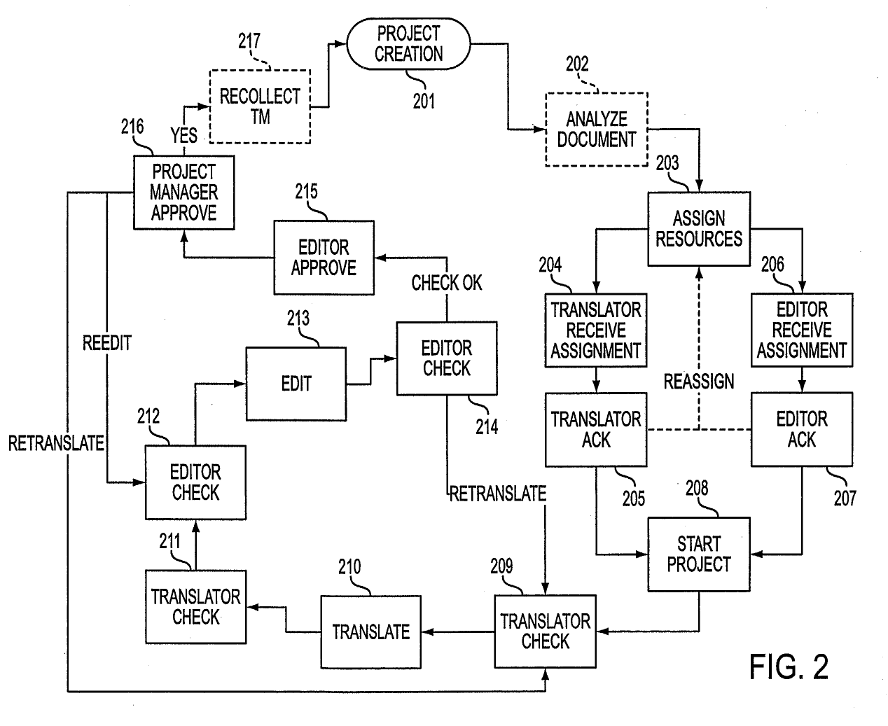

FIG. 2 shows an example of a project model in accordance with embodiments of the present invention. The specific model shown is for example only as it represents a single client's translation process. Other models are appreciated and considered within the scope of the invention. One aspect of the present invention is to provide a flexible system that may be adapted to fix an individual client's current workflow process. A project is created in step 201. This includes selecting a template that represents the model of the project. For example, for a simple project, the template may be the use of a simple translator and no other resources. Alternatively, a more complex template may be used. Next, the program manager assigns system resources in step 203. In an alternative embodiment, the system may determine who has availability and automatically assign the resources based on availability, correct subject matter, correct language pairs, and the like. In another alternate embodiment, the system may analyze the document to be translated (step 202) and determine how much time the document would take to translate based on, for example, the language pair used, an estimated time per translation of size of document, an estimated time per number of matching translation memory pairs, and an evaluation of the efficiency of each individual translator (and editor and troubleshooter, for instance).

Once the resources have been assigned in step 203, the translator receives the assignment 204 and replies with acknowledgement in step 205. If no acknowledgement, then the system attempts to reassign resources in step 203. Similarly, the editor receives an assignment in step 206 and acknowledges the assignment in step 207. If the editor is unavailable for editing or otherwise refuses the assignment, the editing role is reassigned (step 203).

Next, the project is started in step 208. First, the translator checks the document in step 209. Next, the translator translates the document (step 210), checks the translation (step 211), and sends it to the editor (or at least makes it available to the editor by, for example, sending it back to the project manager or system housing all documents).

The editor checks the document 212, edits the document 213 and performs a check (step 214) of the translated document against the original (or source) document to ensure the correct translation was achieved. This check may include reviewing the source document, the translated document, any instructional materials or instructions, and provided translation memories. If needed, the editor may send the translated document back to the translator for revision (steps 209 and 210). Otherwise, the editor approves of the translation 215 and forwards the approved translation to a project manager (directly via, for example, email or indirectly by posting it to a central location, for example, at the client itself). Next, the project manager reviews the translated document in step 216. If the project manager does not approve of the translation, the document (or an indication of the problem with the document) may be returned to the editor to check the translation or editing job performed on the translation (212) or to the translator (209) to check the translation. If the project manager approves of the translation, the project is marked completed and the resources are ready for the next assignment. Alternatively, each resource may be individually freed from the project once their work has been shifted to the next phase. This alternative approach permits the resources to start on new projects sooner rather than waiting for the final project manager to approve of the project.

Also, as shown with broken lines, optional step 217 reflects the recollection of translation memories having been generated from the translation of the original document into the new document.

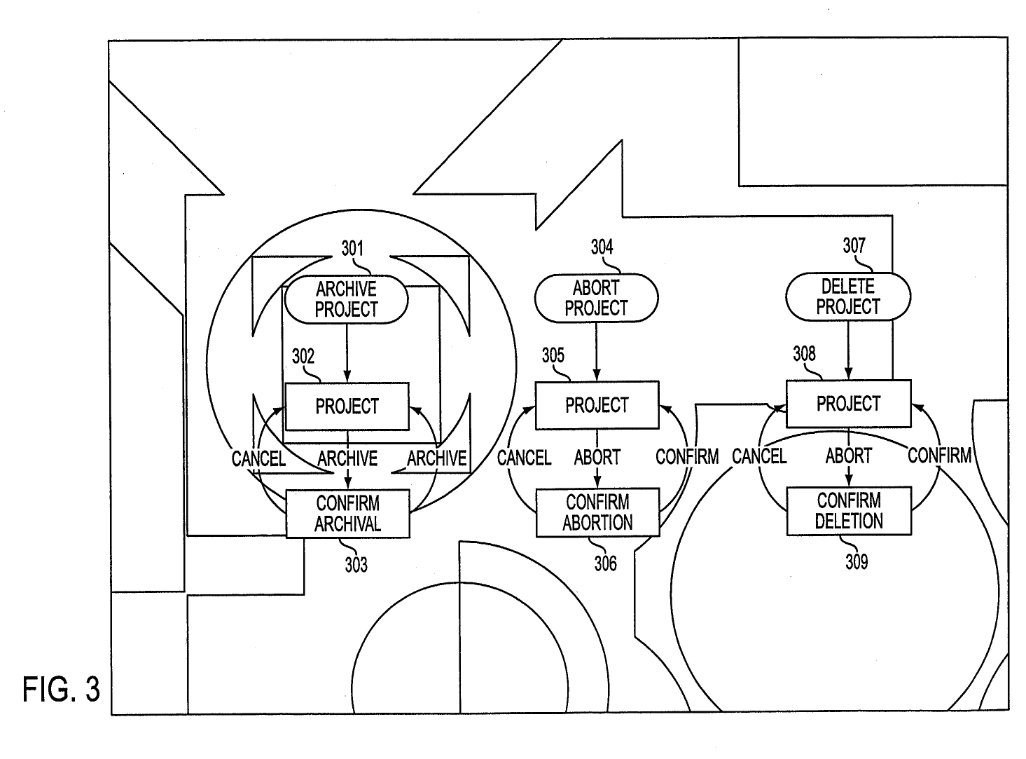

FIG. 3 shows archival, abortion, and deletion processes in accordance with embodiments of the present invention. When creating the project, the project manager may decide not to continue with a current project. The project manager may archive the project (process 301 with archiving project 302 and confirming the archival 303), may abort the project (process 304 with abort project 305 and confirming the abortion 306) and may delete the project (process 307 with deleted project 308 and confirming deletion 309).

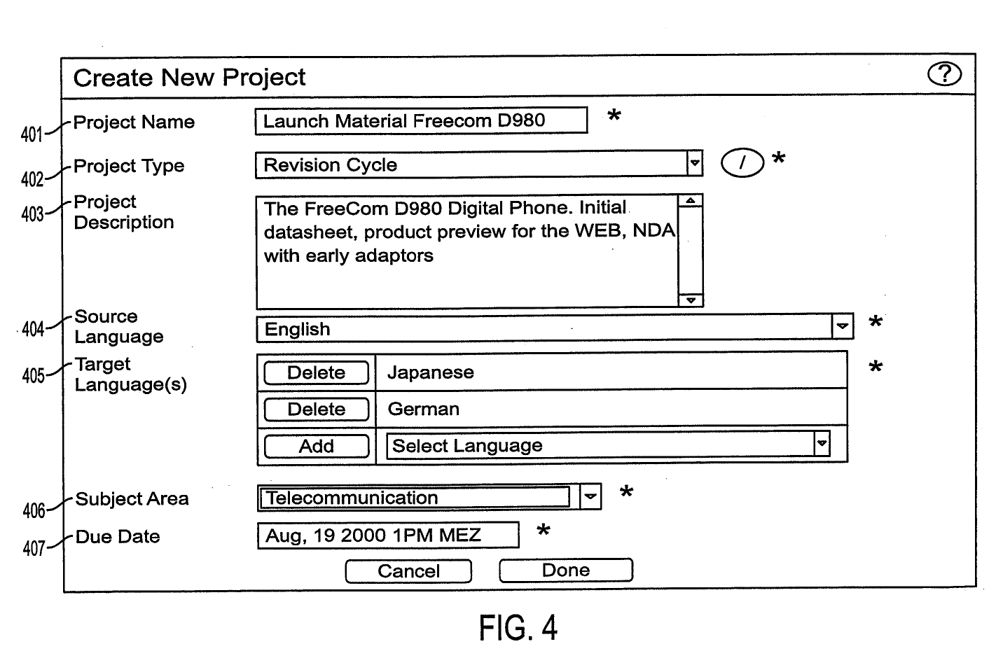

FIG. 4 shows an interface for receiving information from a project manager for creating a new project in accordance with embodiments of the present invention. The user interface includes a place for a project name 401, a project type 402 (which may include selectable templates for the type of project to be created), a project description 403, a source language 404, target languages 405 selectable from predefined choices, a subject area 406 and a due date 407.

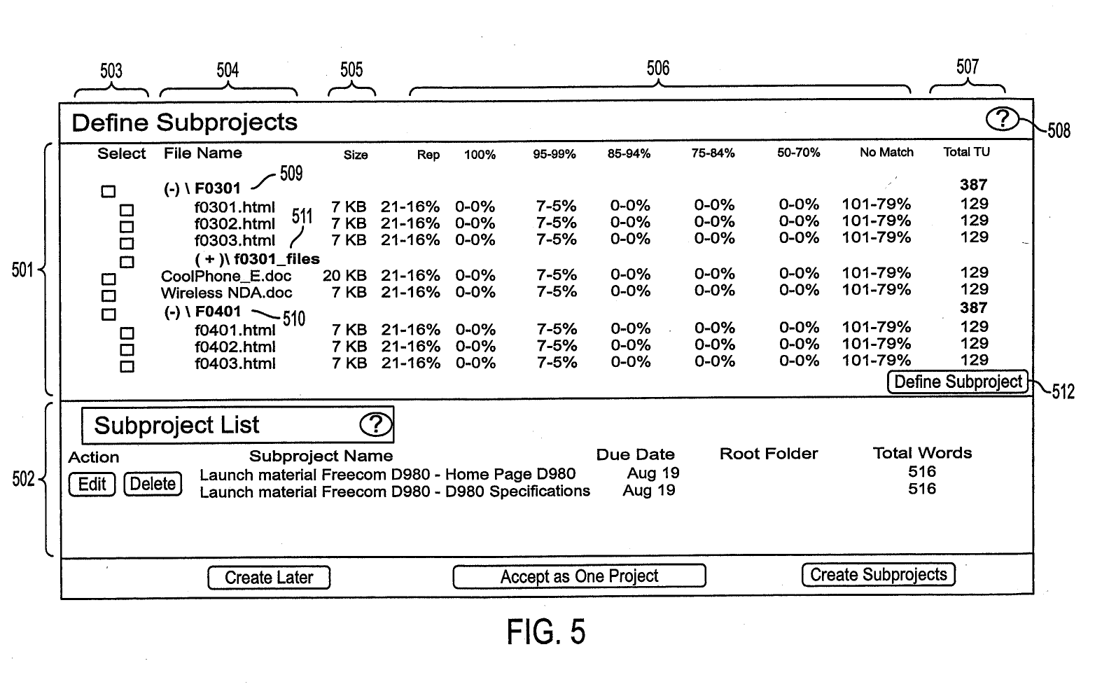

FIG. 5 shows another interface for a project manager for defining subprojects in accordance with embodiments of the present invention. The user interface is split into two sections: section 501 in which a program manager selects files to be included in a subproject and section 502 that lists the previously designated subprojects. Section 501 includes check boxes 503 to permit a program manager to individually select files. Section 504 provides the names of the files in the project. The files shown in 504 may also be collections of subfiles 509, 510 and 511 that may be expanded to show the files in the collections. Selecting a collection includes selecting the sub files as well.

Section 505 shows the file size. The file size may be helpful to determine which files to provide to a translator. For example, a project manager may split up subprojects with a 10 kb file going to a first translator and ten 1 kb files going to another translator so that each translator has approximately the same amount of information to review.

Section 506 includes an analysis of the files as to the number of repetitions, the percent match between a sentence from a source document and a sentence stored in the translation memory. Section 507 shows the total translation units used. Section 512 permits a program manager to select a variety of files the select “define subproject” to store the files together as a separate subproject, displayable in subprojects list 502. Finally, a user has the options of creating subprojects at a later time, accepting all subprojects as a single project and creating more subprojects.

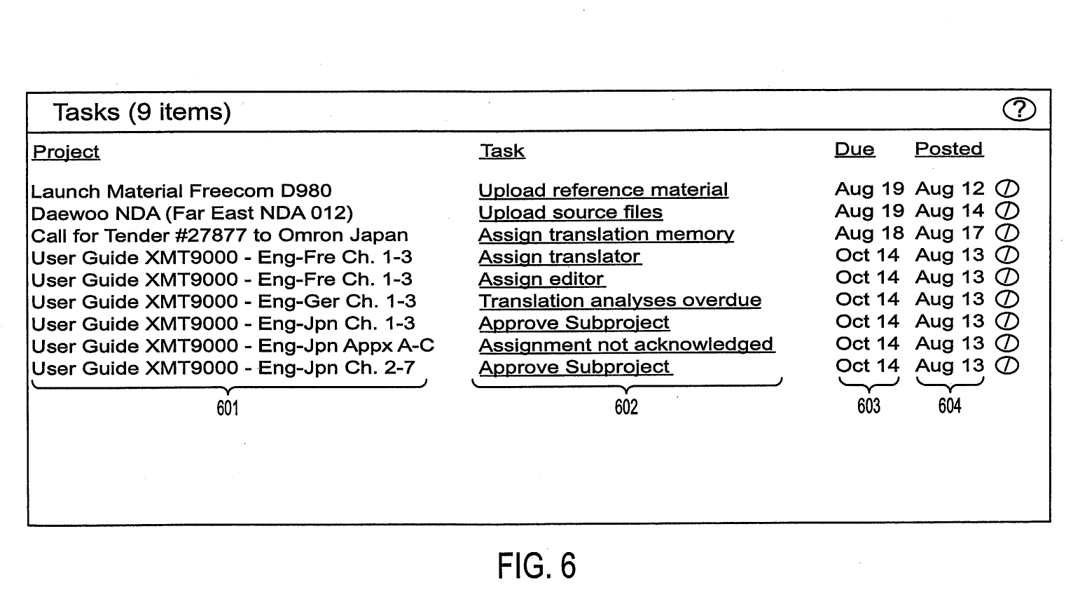

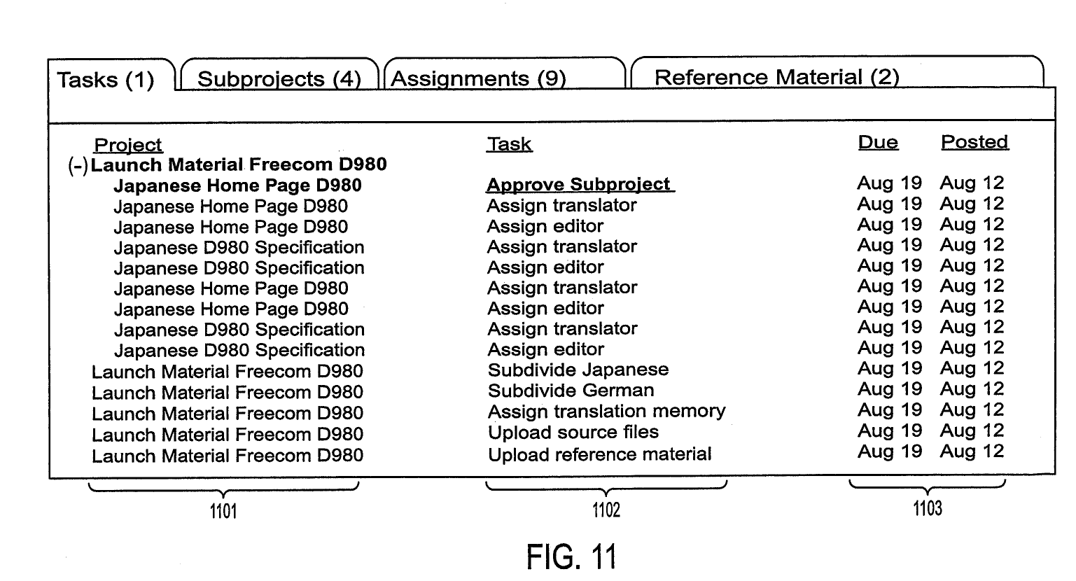

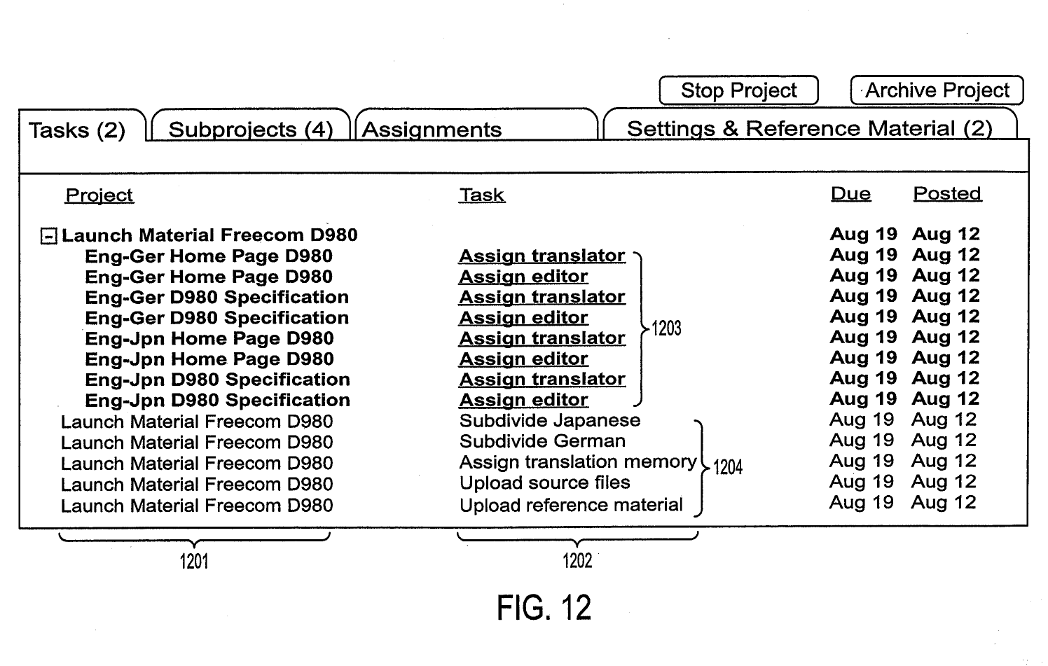

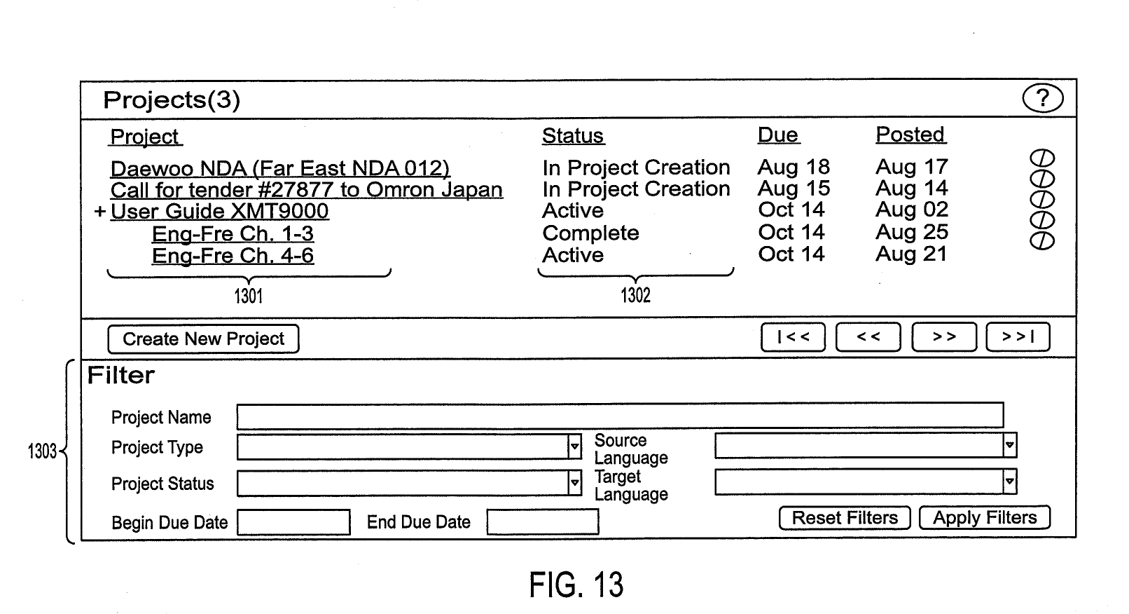

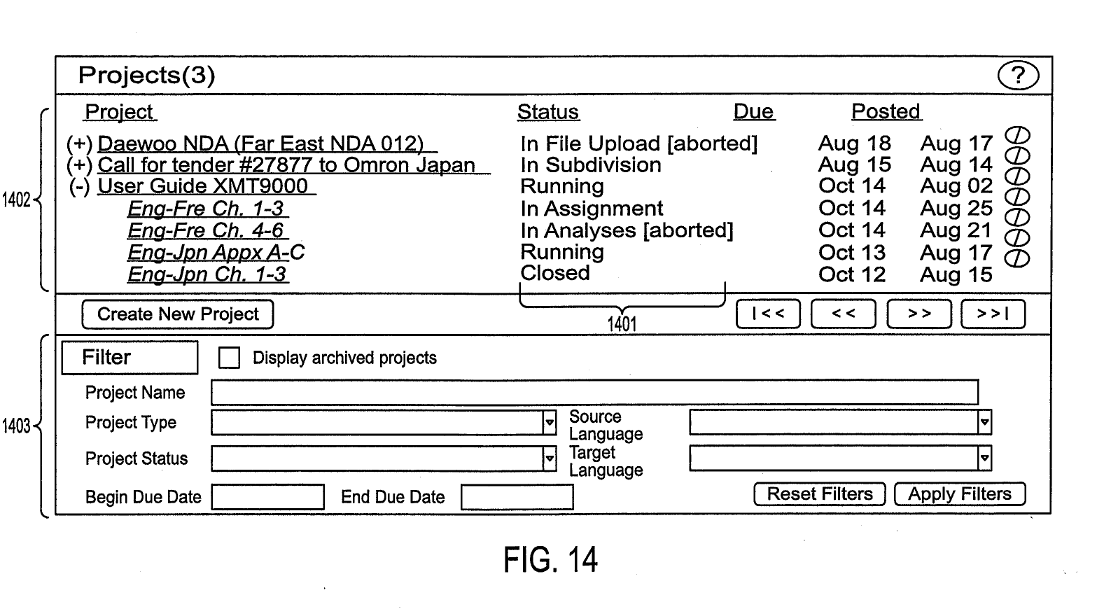

FIGS. 6, 11, and 12 show various task lists for a program manager in accordance with embodiments of the present invention. FIGS. 13 and 14 show status lists for the various projects. Section 601 of FIG. 6, section 1101 of FIG. 11, section 1201 of FIG. 12, section 1301 of FIG. 13, and section 1402 of FIG. 14 show various projects and subprojects in various states of expansion. Adjacent to each project or subproject is a task associated with the subproject (see section 602 of FIG. 6, section 1102 of FIG. 11, section 1202 of FIG. 12, section 1303 of FIG. 13, and section 1401 of FIG. 14). The tasks displayed include items that need to be completed and items that have been completed (and may contain other alerts). Alternatively, once a task has been completed it may be removed from the task list. To differentiate between uncompleted tasks and completed tasks, the uncompleted tasks may be displayed differently than the completed tasks (for example, using underlining, different colors, bold font face (for example, tasks 1203 are bolded vs. tasks 1204 which are not), italics font face, and the like). The tasks that may be appropriate to display to a program manager include the following:

Upload reference material;

Upload source files;

Assign translation memory;

Assign translator;

Assign editor;

Assign troubleshooter;

Translation analysis overdue;

Approve subproject;

Assignment not acknowledged;

Approve subproject; and

Subdivide language (for example, German).

User interfaces may also include dates the projects and subprojects were posted and the dates they are due (see sections 603 and 604 of FIG. 6, and section 1103 of FIG. 11, for example).

Continuing with FIGS. 13 and 14 additionally show filter interfaces (1303 in FIG. 13 and 1403 in FIG. 14) that permit a program manager to selectively filter for certain projects (for example, by project name, project type, project status, source language, target language, begin due date and end due date. Messages that pertain to the status of a project include:

In project creation;

Active;

Complete;

In file upload;

Aborted;

In subdivision;

Running;

In assignment;

In analysis; and

Closed.

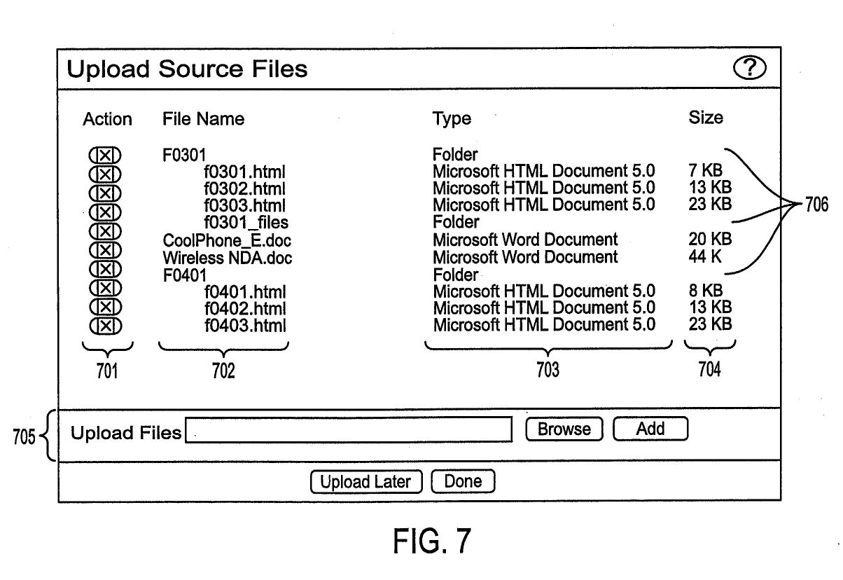

FIG. 7 provides a user interface for a program manager to upload source files. Section 701 may indicate that the file shown in 702 has been selected for uploading. Section 703 includes the type of document to be uploaded (for example, Microsoft Word files, folders containing other files (including folders 706), HTML files, Excel files, and the like). Section 704 includes the size of the files to be uploaded. Section 705 includes an interface permitting a program manager to add new files for uploading.

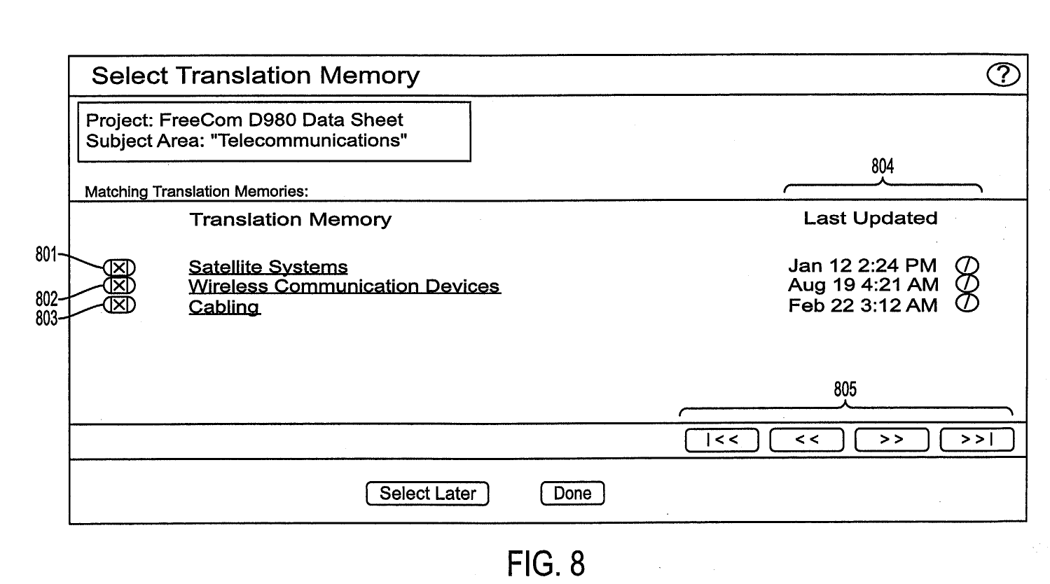

FIG. 8 shows an interface permitting a program manager to select which translation memory may be most applicable to the project being created. Here, the project is the “FreeCom D980 Data Sheet” with the subject area of “telecommunications”. Matching translation memories that are present in client's repository 3301 include satellite systems 801, wireless communication devices 802, and cabling 803. Using check boxes (or other equivalent designating techniques) the program manager may select one or more memories to upload for a project. While one memory may be very good for a particular subject area, the possibility exists that the memory may be smaller than other related memories. Accordingly, the present invention permits multiple memories to be designated for a project. Section 804 shows when the translation memory was last updated (which may be important in that older memories may not be as useful). Finally, section 805 permits a program manager to skip around during the project creation process.

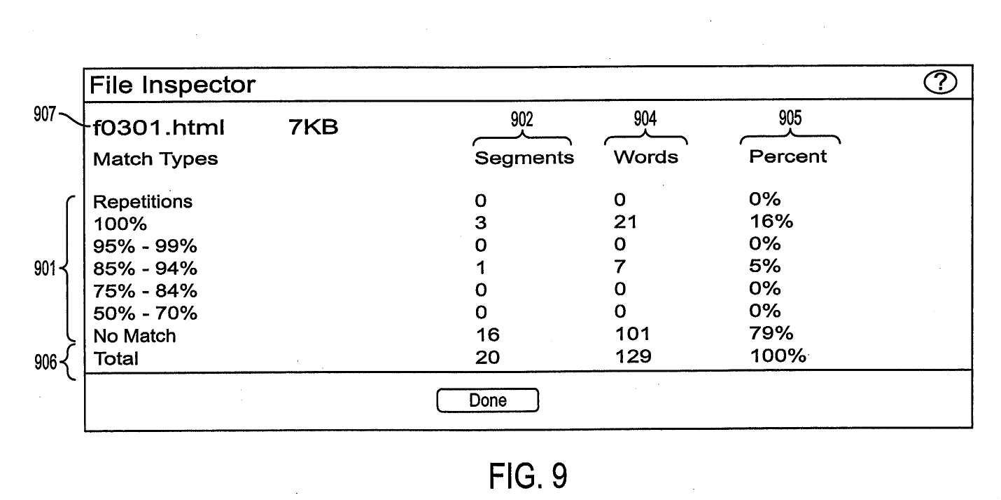

FIG. 9 shows the results of a file inspector having analyzed a subject file. Here, the file that was analyzed was <f0301.html>of 7 kb in size. The file inspector shows an analysis of the match types (repetitions, 100% match, 95-99% match, 84-94% match, and the like) in section 901. Matching information may displayed in terms of matching segments 902, words 904, or percent of document analyzed 905. Finally, section 906 provides the subtotals of the file inspection. In one embodiment, the program manager may use the file inspector to determine the workload that may be required for a translator. For example, a file with a higher percentage of no matches may require more effort to translate than a file of the same size with 80% of the document having an 85-94% match with existing translation memories.

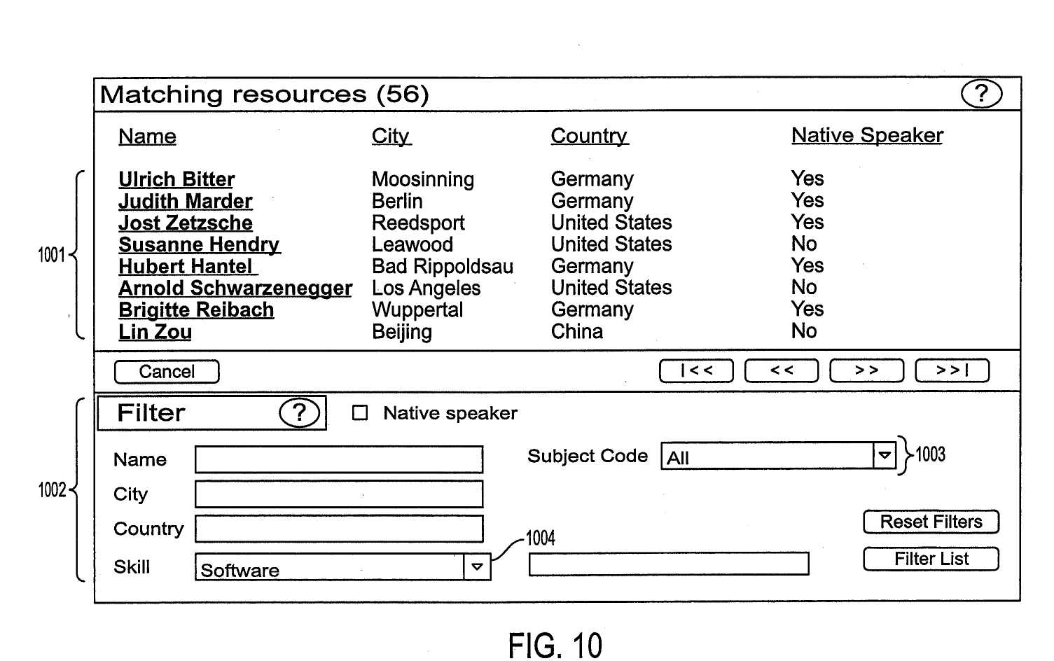

FIG. 10 shows resources matching search criteria in accordance with embodiments of the present invention. In this example, section 1001 displays resources matching search criteria (for example, translators who can translate English to German). Section 1002 permits a user to enter the search criteria. Section 1003 permits a user to enter a subject code. Section 1004 permits a user to enter a skill on which to search. For example, the skill may be in debugging HTML code for proper. So, if an error arises in translating one HTML page into German from English and an error occurs in the resultant page, a troubleshooter with a specialty in software would be useful to fix the error.

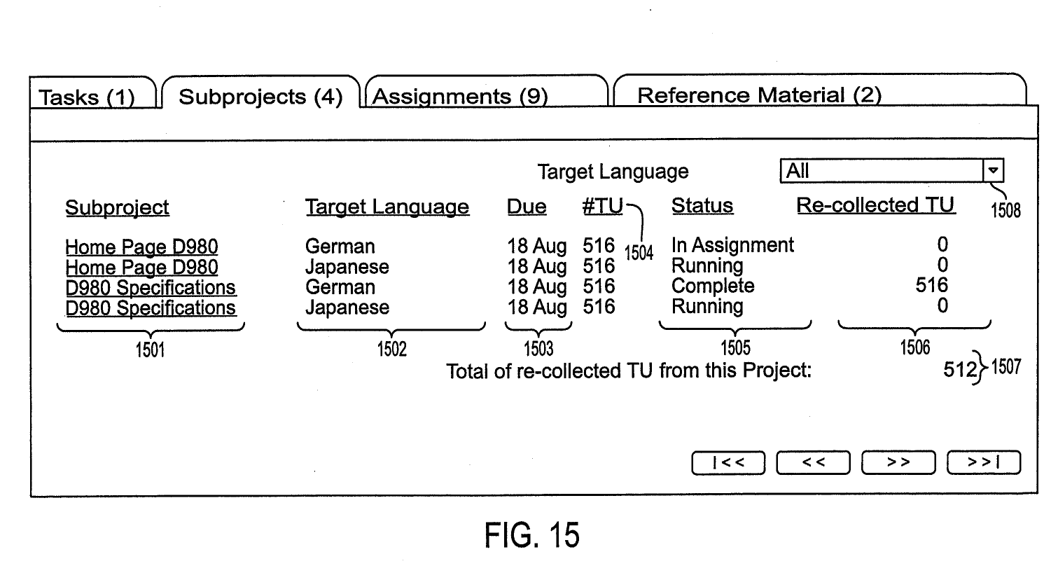

FIG. 15 shows a status report of a number of subprojects in accordance with embodiments of the present invention. Section 1501 shows the name of the subproject. Section 1502 shows the target language of the subproject. Section 1503 shows the due date. Section 1504 shows the number of translation units available for translation. In one instance, a translation unit may be equivalent to a sentence. So for the four subprojects shown in section 1501, each has 516 sentences. Section 1505 shows the status of each subproject. When complete, section 1506 shows the number of recollected translation units. Here, as the German version of “D980 Specifications” has been completed, the system has recaptured the translation units. In this instance, the system recaptured 516 sentence pairs. Section 1508 permits a user to filter the subprojects based on the target language. Section 1507 shows the number of total collected translation units.

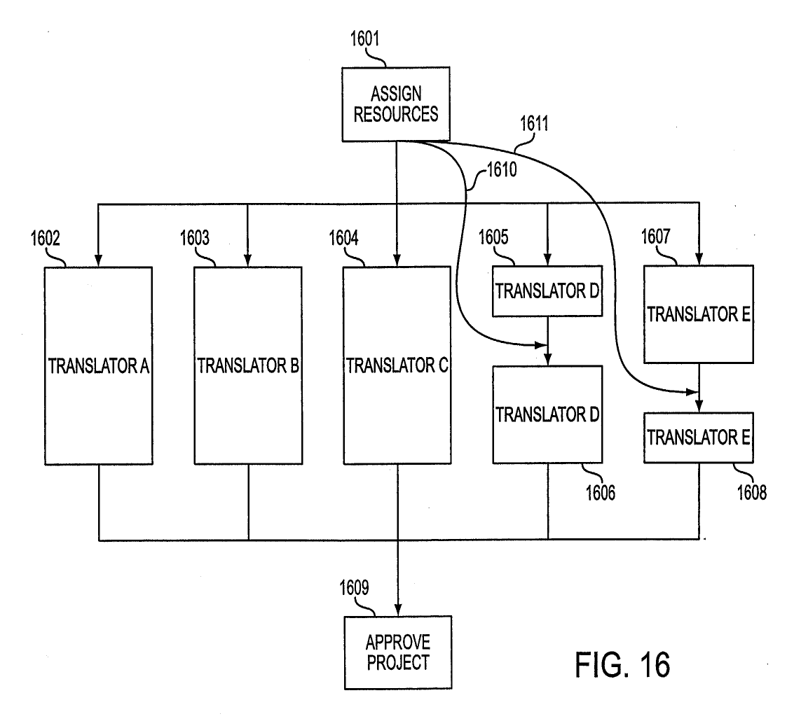

Once a project has been released, some translators may finish earlier than expected and others take longer than expected. FIG. 16 shows multiple translators working on a project in accordance with embodiments of the present invention. A project manager assigns resources in step 1601. Multiple translators (A, B, C, D, and E) start working on their assignment for the project. While translators A, B, and C are working steadily on their subprojects 1602, 1603, and 1604, translator D experienced difficulty on subproject 1605. As translator E may have specialized knowledge or background in the area that gave translator D difficulty, the system reassigns the uncompleted portion of subproject 1605 from translator D to translator E as subproject 1608. Depending on where translator E is on subproject 1607, the system may permit translator E to finish the subproject 1607 or may request that translator E stop work immediately and begin new subproject 1608. In this example, the uncompleted portion of subproject 1607 is reassigned to translator D. In this instance, translator E may not have been originally assigned subproject 1605 due to time constraint reasons, translator E may have been involved with other subprojects, etc., thereby preventing translator E from working on subproject 1605 initially. Finally, the program manager approves of the final project in step 1609.

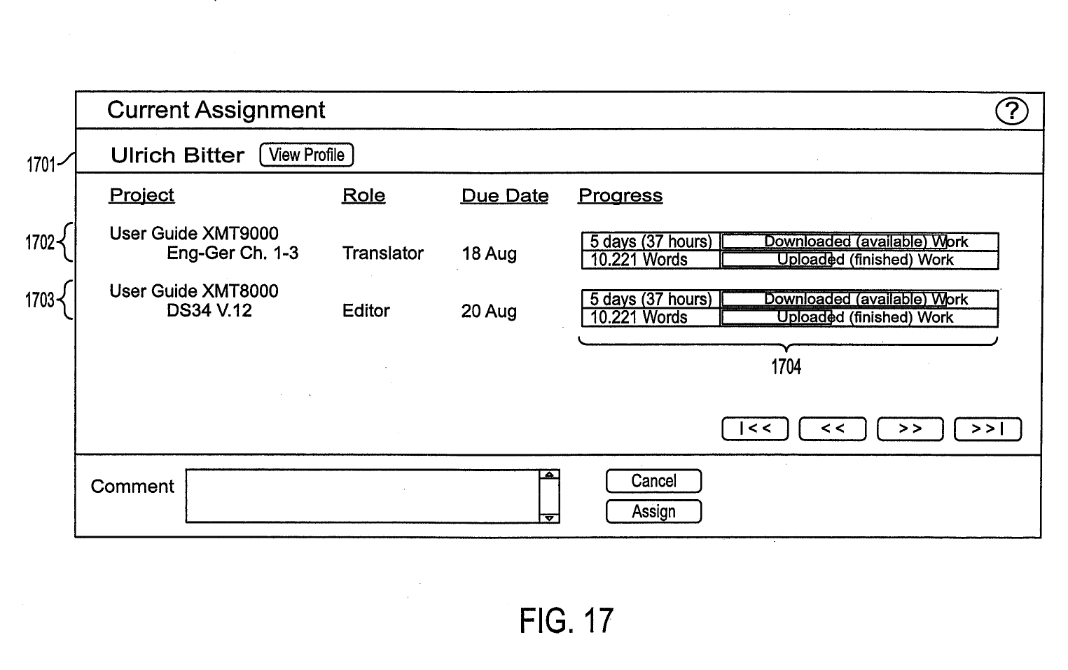

FIG. 17 shows the current assignment and progress of a resource in accordance with embodiments of the present invention. The progress of translator D above was monitored by the system. This monitoring may have been through the use of regular status updates generated by the resource, embedded commands in the source document to be translated to fire an event to an event manager with the program manager indicating that the resource has hit one of the embedded commands (for example, translated the first word on the 30^{th} page of a document), and other known methods for monitoring the progress of a resource. FIG. 17 represents a user interface at the program manager that shows the status of a resource 1701 (here, Ulrich Bitter) in two projects 1702 and 1703. The status may be graphically shown by the way of bar charts and/or textual information in 1704. The status may include the number of hours consumed by the subproject, the number of words processed, the consumption of available work, and output of completed work, for instance. Other information may be provided as well or in place of the above-identified information as useful to the program manager for monitoring status of the resource.

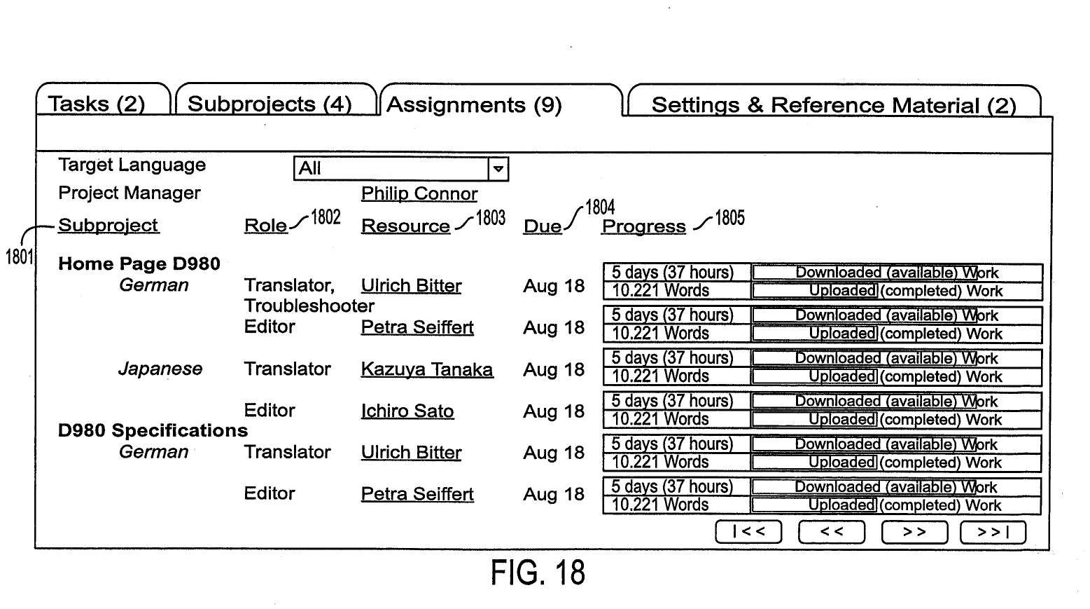

FIG. 18 shows the status of subprojects with their current assignments in accordance with embodiments of the present invention. Here, the system displays information for each subproject 1801 with the roles 1802 of the resources 1803 assigned to the subproject. The respective due dates for each subproject is shown in 1804 with the progress of each resource shown in section 1805. The group view of multiple resources may help the program manager to better manage the workflow of the resources and proactively identify problems.

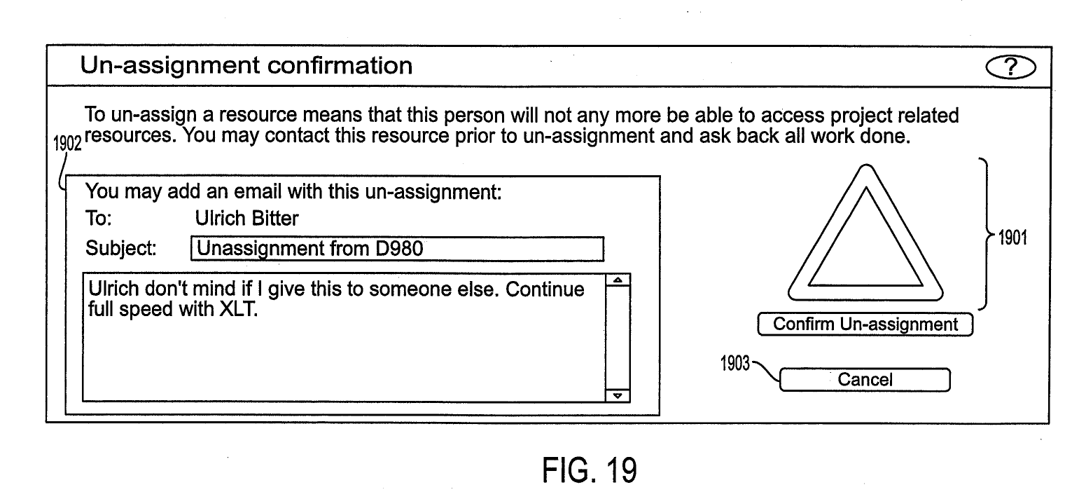

FIG. 19 shows the result of a project manager un-assigning a resource in accordance with embodiments of the present invention. Here, the project manager has requested that Ulrich Bitter be unassigned from a project with a text message in 1902. Confirmation 1901 or cancellation 1903 is needed before the resource is asked to stop working on his subproject.

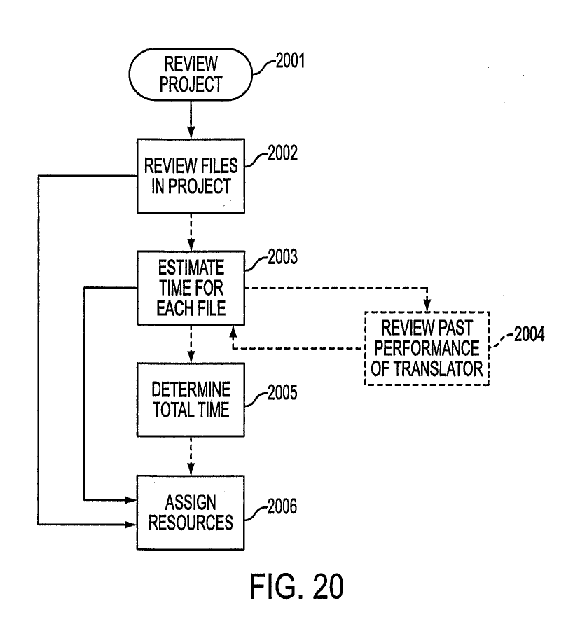

To prevent the need for un-assignment, the project manager attempts to properly assign resources based on a variety of factors including resource throughput, skill of the resource, and the like. FIG. 20 shows a process for assigning resources in accordance with embodiments of the present invention. Here, the project manager is to assign resources starting with reviewing the project 2001. The program manager reviews the files that comprise the project 2002. The program manager may then make a determination of the resources best suited for the subprojects and assign the resources in step 2006. In an alternate embodiment, the program manager estimates a time for each file based on the size (or other criteria) and uses this determination for each file to assign resources 2006. In a further embodiment, the program manager determines the total time 2005 for each subproject and uses this information to balance the size of each subproject. The total time may be determined as the sum of the estimated time of each subproject. The time for each subproject may be determined in variety of ways using various algorithms including:

1. Subproject time==(size of subproject files)(estimated translation rate);

2. Subproject time==sum of, for all N, (size of subproject file N) ((percentage of 80%+matches)(estimated translation rate for 80%+matches)+(percentage of 50-79%+matches)(estimated translation rate for 50-79%+matches)+(percentage of no matches)(estimated translation rate for 50-79%+matches).

Other formulas varying the granularity (the number of different estimated rates, the number of percentage groups, etc.) may be used as well to improve the estimate of subproject time. It will be appreciated that the In some cases, the project manager may not care the exact estimate of time. In other cases, the estimate of time may be a primary factor in determining resource assignments. The estimate may reflect different language groupings, different subject matters, different skill of the translators and the like.

Finally, the system may include the review of actual past performance of each resource (here, the past review of each translator) in step 2004. This actual review of a selected translator improves the accuracy of the estimate by using actual figures representing specific translators, rather than an estimate for all translators.

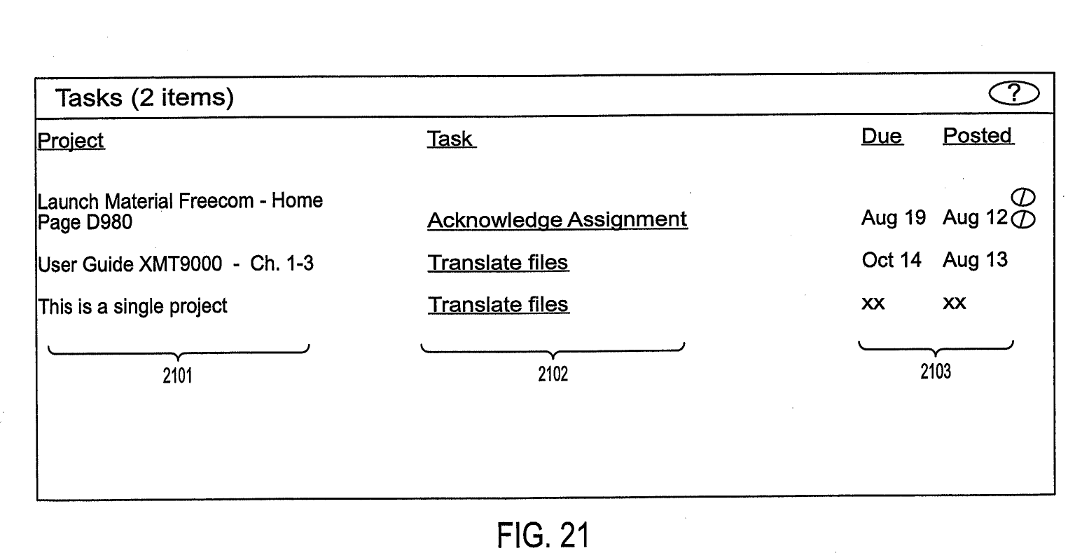

Turning to the translators, the resources may also be provided with an interface for monitoring their tasks as well. FIG. 21 shows a task list for a translator in accordance with embodiments of the present invention. Here, the translator views the current projects in section 2101 and the pending tasks (shown for example in bold to indicate that the tasks have yet to be accomplished) in section 2102 with a showing of posted dates and due dates in section 2103.

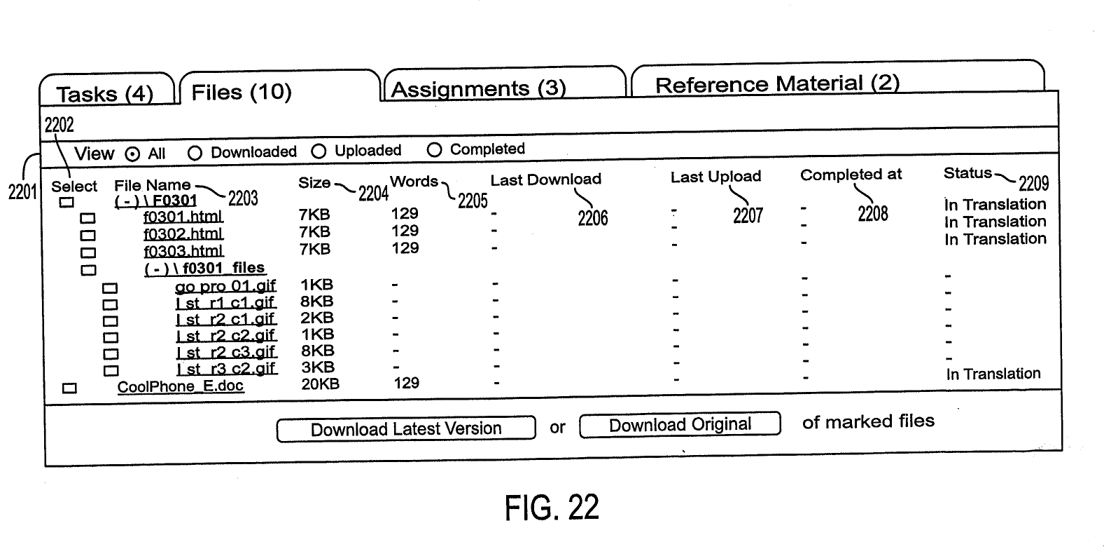

FIG. 22 shows source files available for a resource to download in accordance with embodiments of the present invention. The resource is provided an interface 2201 for selection (via selection boxes 2202) with the file names in section 2203 (whose location may reflect subdirectories of files) with the file size of each file 2204. Other information may be provided for each file including the number of words 2205, the date of last download 2206, the date of last update 2207, the completion date 2208, and the status 2209. If the file was updated more recently than the resources last download, the resource is provided with the option of downloading the latest version. This process may also include an alert sent to the translator to signal the translator to check to see if a file has been updated. In one embodiment, by the fact that translation memories are created during the translation process, minor updates to existing source documents will not consume significant amounts of time to process. This is because most of the content of the source documents will have already been translated by the translator.

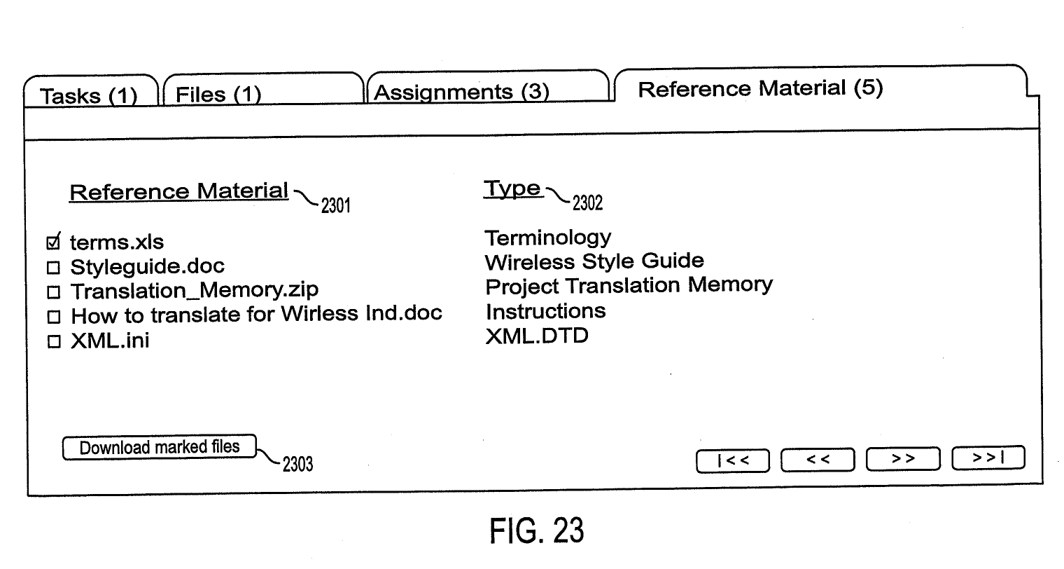

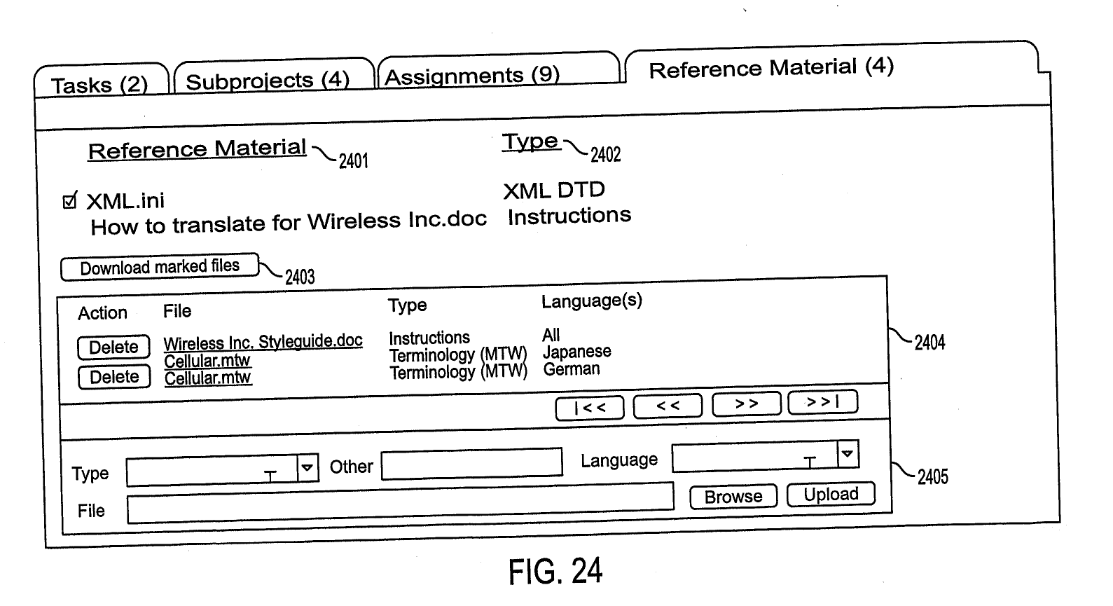

FIGS. 23 and 24 show reference materials available for a resource to download in accordance with embodiments of the present invention. In FIG. 23, a resource is presented with a list of reference materials 2301 as identified by their name. The corresponding description of the type of file is found in section 2302. The resource is able to designate material for downloading (using for example check boxes) and selecting “download marked files”(button 2303). The reference materials may include instructions, style guides, suggested translations of terms and the like.

FIG. 24 shows more information to the resource as including section 2404 listing previously downloaded reference materials in addition to the presently available reference material 2401 and type 2402. The resource may filter based on a language selection 2405.

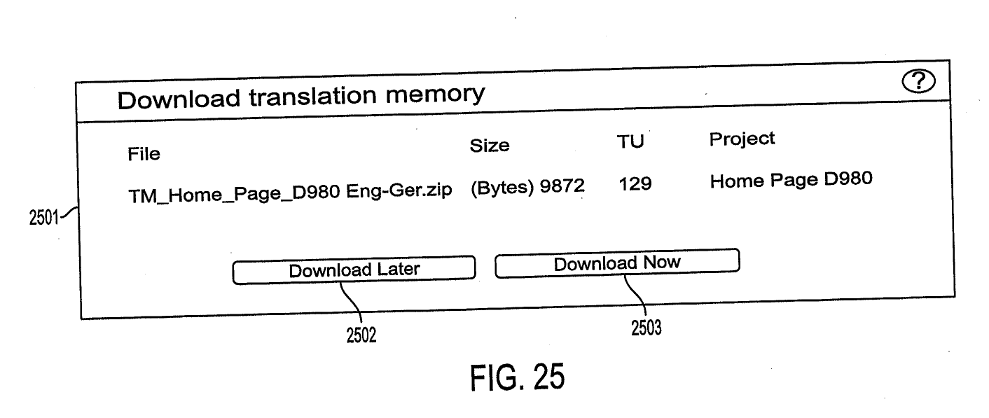

FIG. 25 shows a translation memory available for a resource to download in accordance with embodiments of the present invention. Section 2501 is provided to a resource specifying the translation memory to be used for a subproject. The resource is provide with the options to download now 2503 or download later 2502.

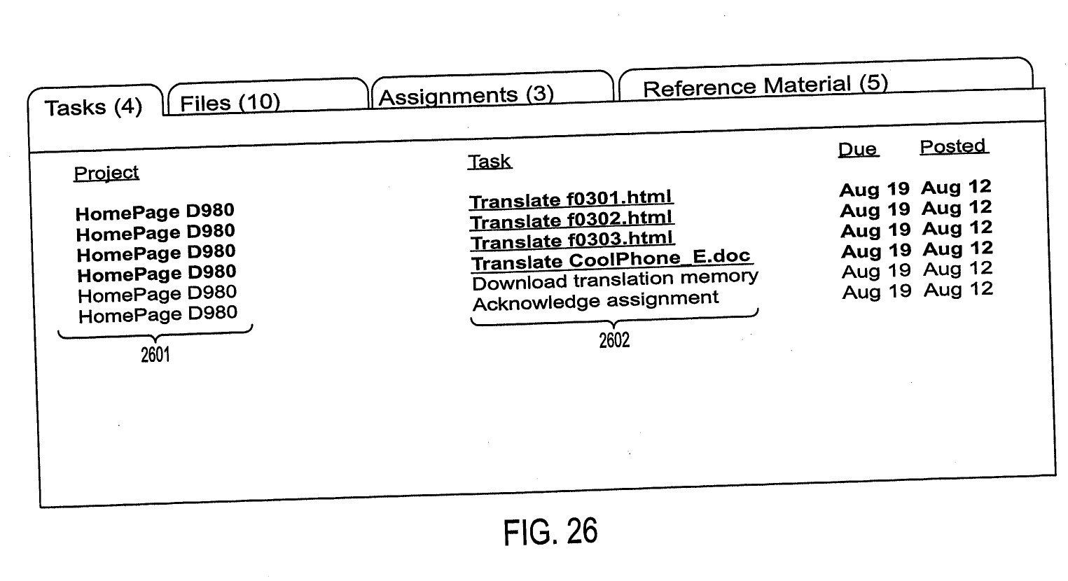

FIG. 26 shows a task list for a resource in accordance with embodiments of the present invention. The task list includes a project listing 2601 with corresponding tasks 2602. Uncompleted tasks may be highlighted to indicate that they have yet to be completed (here, shown in a bold faced font).

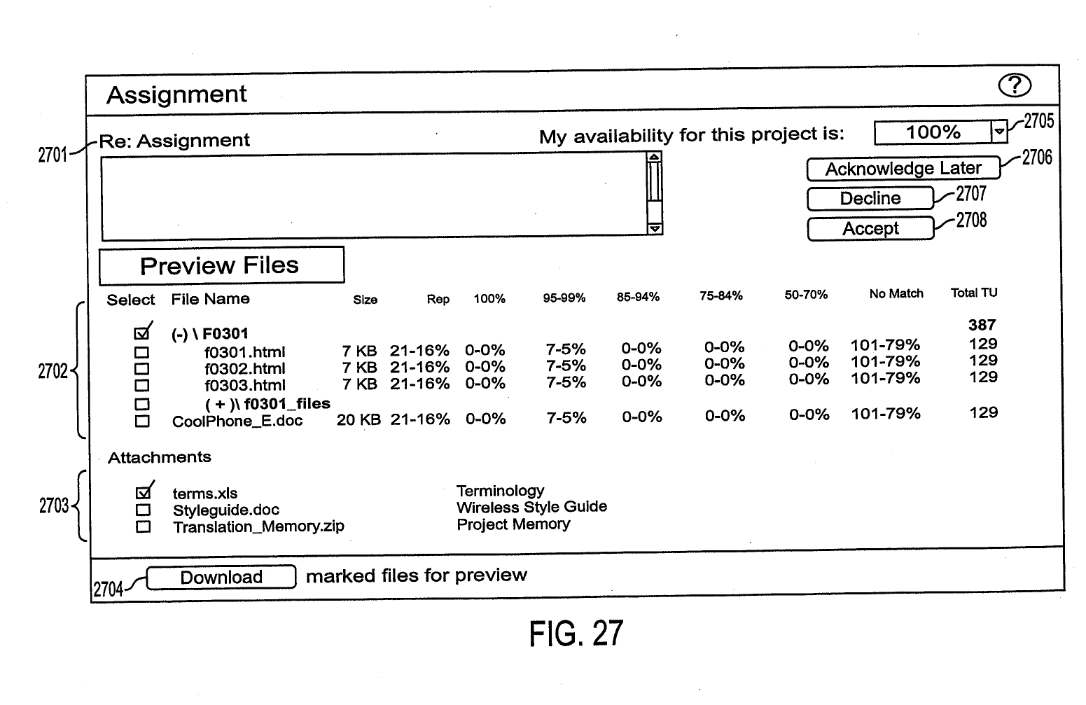

FIG. 27 shows an assignment confirmation form 2701 available for a resource in accordance with embodiments of the present invention. As shown in FIG. 1E, a resource may acknowledge an assignment. The form 2701 includes a preview section where the resource may review an analysis of the file (previously discussed above with respect to the file inspector of FIG. 9. The resource selects files from 2702 and reference materials from 2703 and downloads the files or portions of the files for previewing. When replying, the resource may indicate the his availability for the project 2705. Finally, the resource is permitted to accept 2708, decline 2707, and acknowledge later 2706 the assignment.

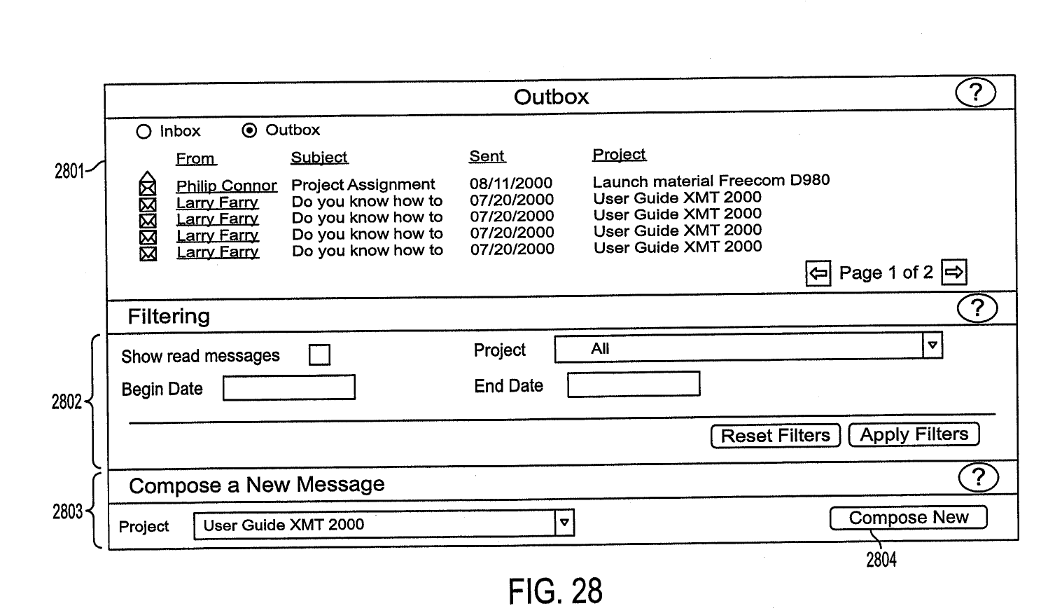

FIGS. 28-30 show communications interfaces in accordance with embodiments of the present invention. The system provides an email conduit for receiving and sending communications to other resources and other entities associated with projects including program managers. Section 2801 shows a list of messages. The messages may be filtered by the project to which each relates. The filtering may be accomplished through interface section 2802 that permits selection of the project. Further, new messages may be composed in section 2803 by selecting a project to which the new message is to be associated and selecting the “compose new” button 2804.

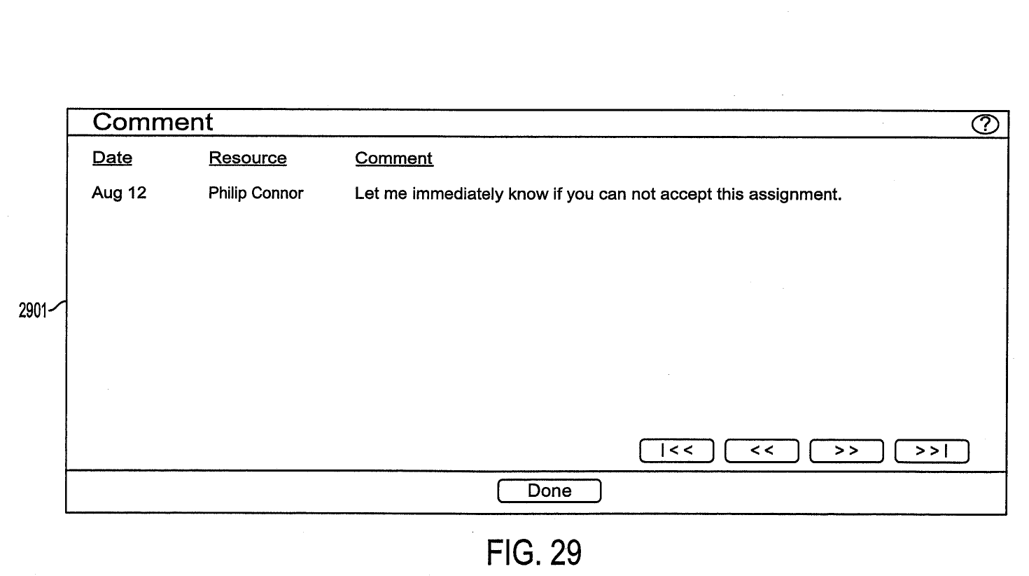

FIG. 29 shows a short email message system 2901 that permits short messages to be communicated between entities. It is appreciated that the email system described herein may be a full email system (akin to Microsoflt Corporation's Outlook Express) or may be an instant messaging system (akin to AOL's Instant Messenger (AIM)).

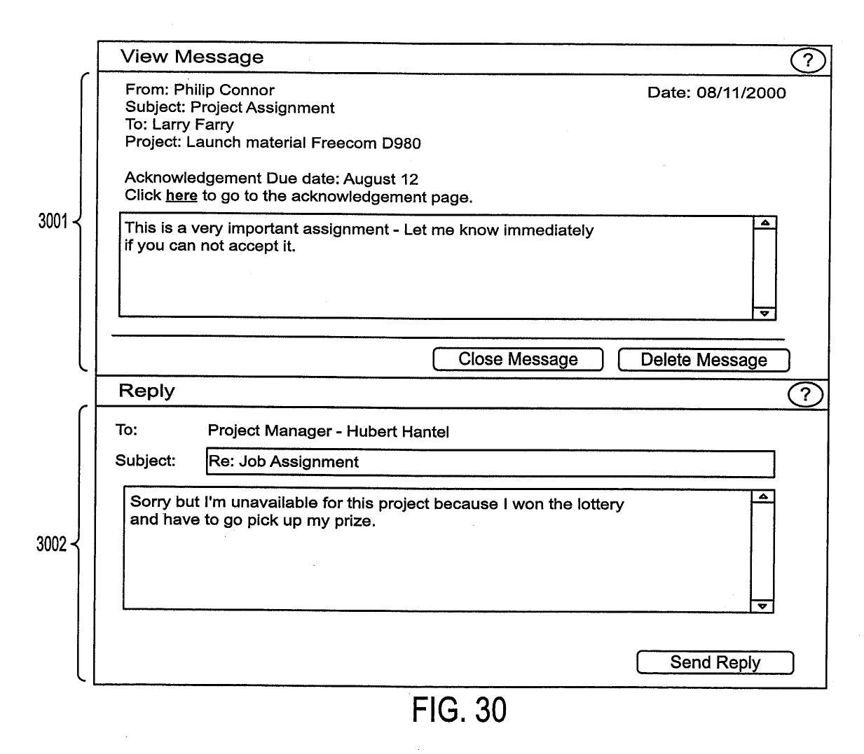

FIG. 30 reflects an interface portion 3001 showing a received message and an interface portion 3002 for composing a reply.

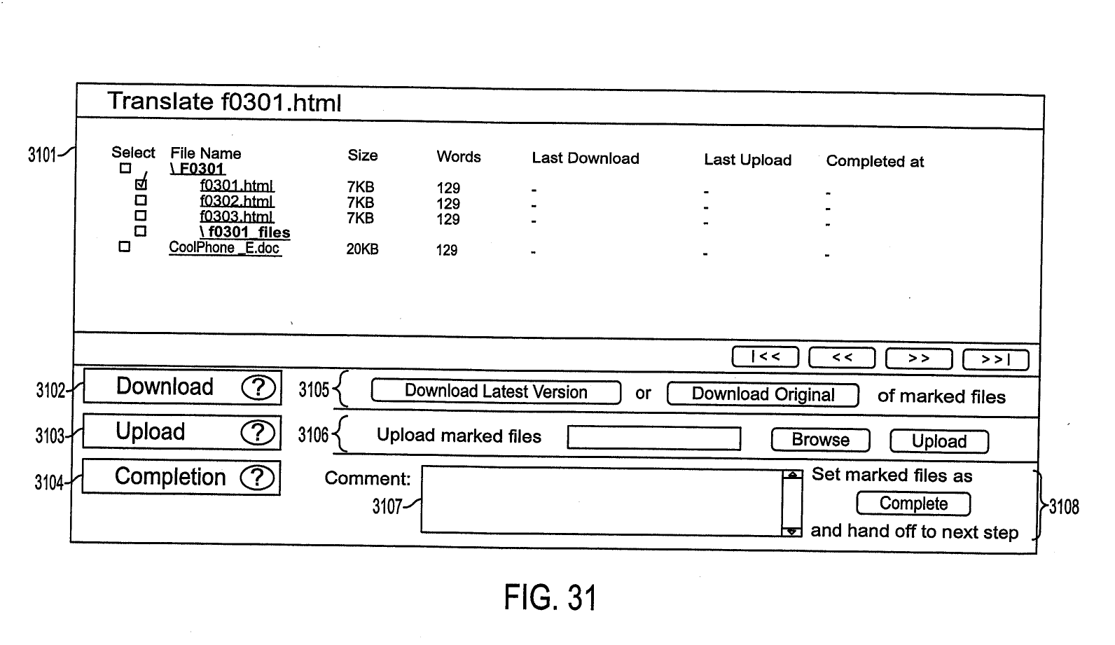

FIG. 31 shows a document exchange interface for a resource in accordance with embodiments of the present invention. Interface portion 3101 provides a translator with the ability to select files for downloading. When a translator selects download button 3102, he is provide with download interface 3105 to select whether a latest version of a file or the original version of a file. When the translator selects upload button 3103, the translator is provided with interface 3106 for uploading files to the system. Finally, when the translator selects the completion button 3104, the translator is provided with an interface for commenting (in window 3107) on the completion of the subproject as well as setting marked files as completed (interface 3108).

FIG. 32 shows a translator's translation interface in accordance with embodiments of the present invention. The translation interface may include that of the Trados Workbench translation tool available from the Trados Corporation of Alexandria, Va.

FIG. 33 shows communication pathways between entities in accordance with embodiments of the present invention. Here, a client's translation memory repository 3301 stores the client's translation memories. A project manager 3302 coordinates with the repository to send and receive information between the resources (here shown as translator 3303, editor 3304, legal counsel 3305, and printer 3306).

The workflow system as described herein may a centralized system as resident with the client (shown generally as 3301) that coordinates all communication flows between entities. Alternatively, the workflow system may be a diversified system in which the project manager becomes responsible for coordinating the interactions between entities.

The above-described system includes translation memories solely from the client's translation memory repository 3301. The company that provides the translation memory to be stored in the client's translation memory 3301 may receive payment for each translation memory pair used as the use of the translation memories reduces the translator's burden and thereby cost to the client.

In another embodiment, each translator stores its own translation memory that supplements the translation memory as downloaded from the repository 3301. Further, in yet another embodiment, a general, non-client specific, translation memory repository 3307 exists that supplements the translation memories from repository 3301. Here, the repository 3307 may provide suggested matches for those segments not contained in repository 3301. Alternatively, the repository 3307 may provide suggest matches for those segments not having a match threshold (with the translation memory from repository 3301) above a predefined threshold (for example, 85%). Finally, the general repository 3307 may always provide suggested translations to supplement those from the client's repository.

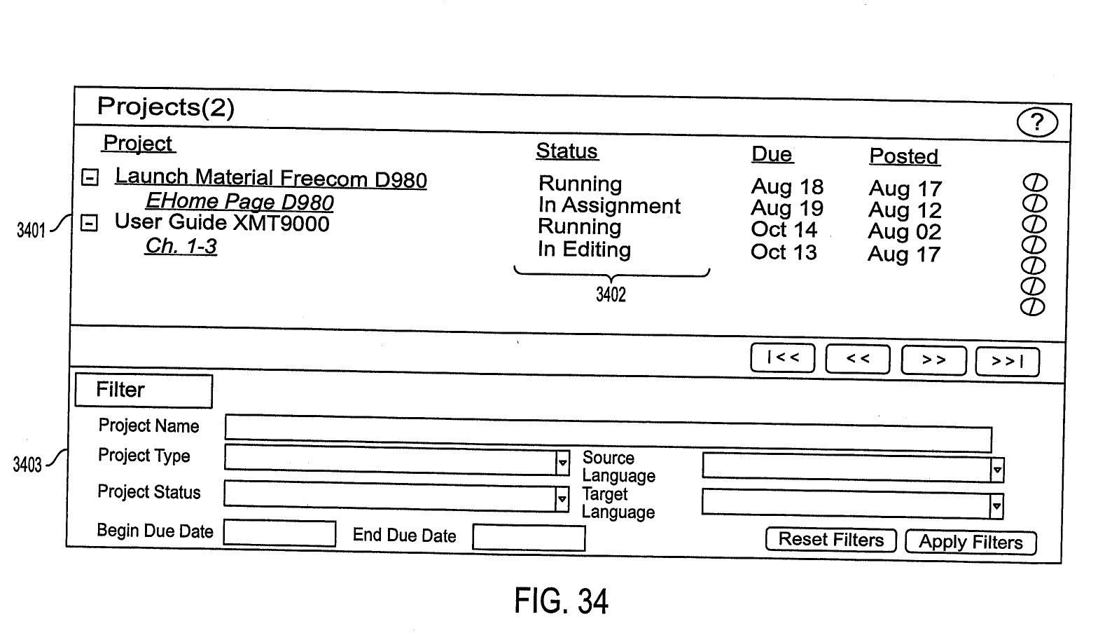

As described above, non-translators may be part of the workflow process. FIG. 34 shows a status list for another resource in accordance with embodiments of the present invention. Here, an editor may check on various projects. Section 3401 shows available projects with a status provided for each 3402. The editor may filter using interface 3403 to filter the projects to filter the projects shown in display 3401.

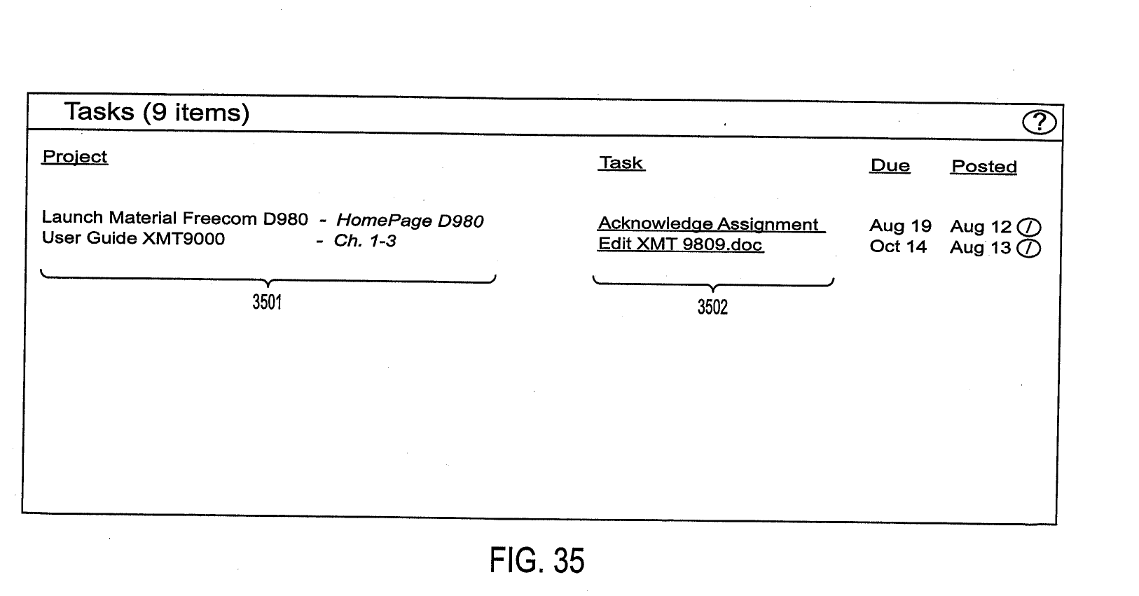

FIG. 35 shows a task list for another resource in accordance with embodiments of the present invention. Similar to the task lists shown above, the editor may also view projects (or subprojects 3501 and the tasks that need to be completed 3502.

As shown in FIG. 1C, step 132, and FIG. 2, step 216, a project manager may approve of the final product of the resources. It is appreciated (and still considered part of the invention) that another entity other than the project manager may be designated to approve the subprojects or projects. This alternative designation would be specified in the selected template used to create the model for the project. For simplicity of explanation, the project manager is used to approve the subprojects and final project.

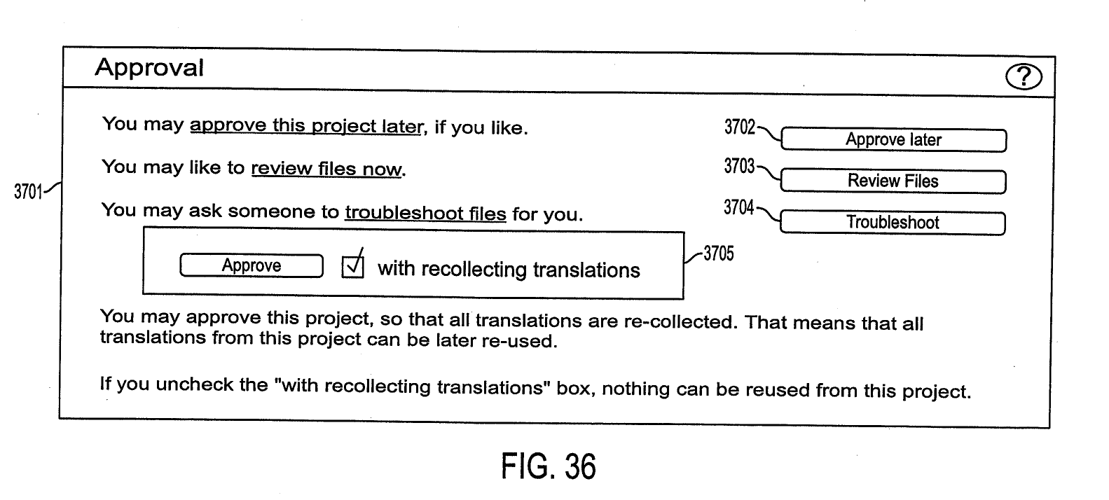

FIG. 36 shows a user interface 3701 for a program manager to approve of a project. The program manager may approve of the project at a later time (through selection of the “approve later” button 3702), may review the files prior to approving (through selection of the “review files” button 3703), and may troubleshoot the files if an error has occurred or to determine whether an error has occurred (through selection of the “troubleshoot” button 3704). Finally, the program manager may approve of the project in interface portion 3705. The program manager is provided with the option whether to recollect the translation memories from the translated document. If the program manager decides to recollect the translation memories, the memories will be stored for later use. If the program manager decides to forego recollection, the project will be approved yet the translation memories of the repository 3301 will not be updated.

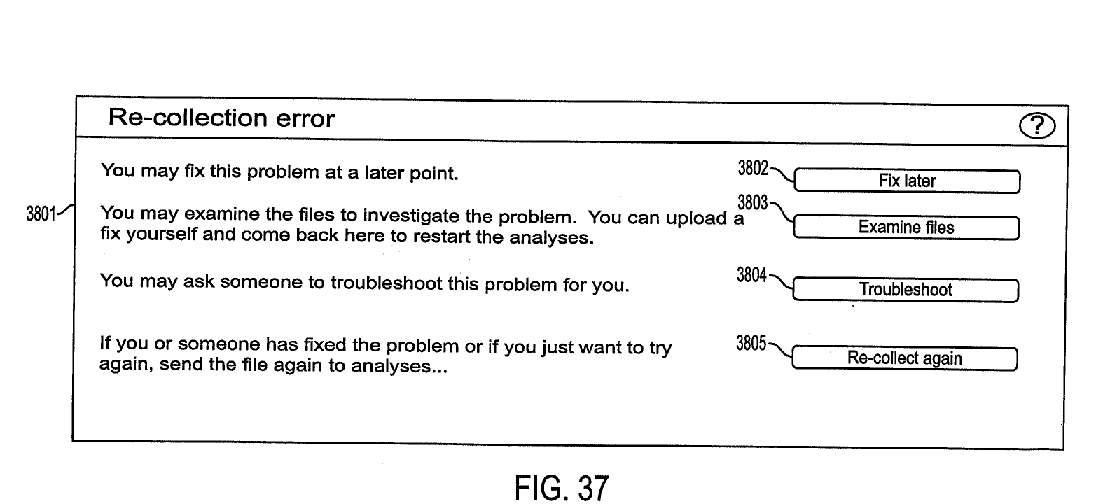

When a resource attempts to upload a file, the file is checked for errors. If the file contains errors, the resource with provided with a set of options to fix the problem with the file. FIG. 37 shows an alert interface 3801 that is provided to the resource. The interface includes a number of options including permitting the resource to postpone fixing the file (through selection of the “fix later” button 3802), allowing the resource to examine the file prior to uploading again (through selection of the “examine files” button 3803), asking another entity to troubleshoot the damaged file (through selection of the “troubleshoot” button 3804), and retrying the uploading process again (through selection the “re-collect again” button 3805).

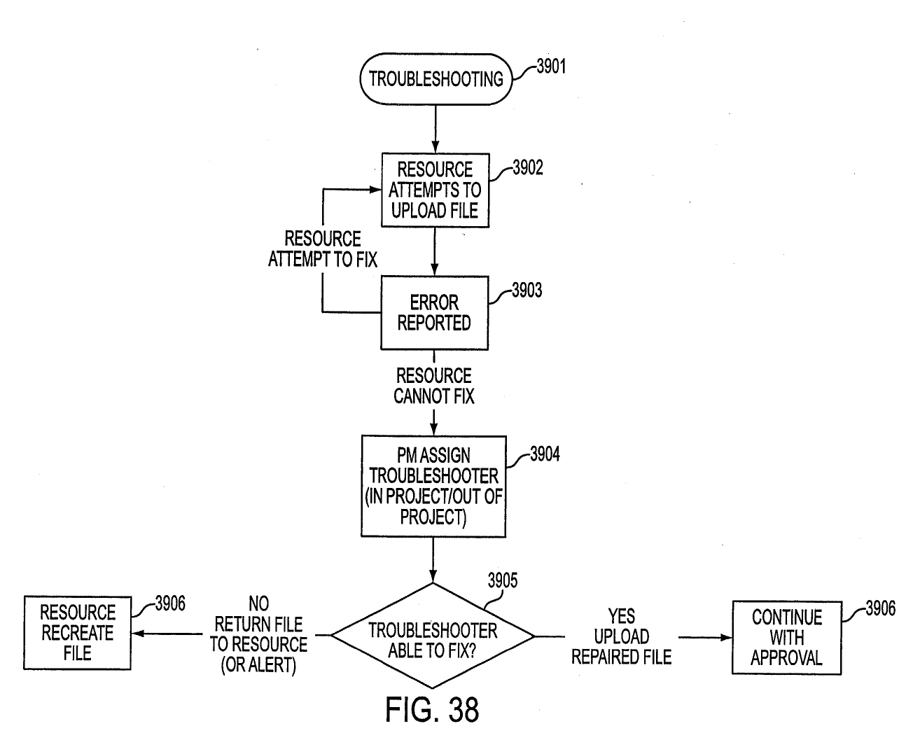

FIG. 38 shows a troubleshooting process 3901 in accordance with embodiments of the present invention. As describe above, a resource attempts to upload a file in 3902. If there is an error in the file, the error is reported to the system in step 3903 and the resource is provided the options of FIG. 37. If the resource attempts to fix the problem, the file is later uploaded again in step 3902. However, if the resource cannot fix the error or does not wish to fix the error, the program manager attempts to assign a troubleshooter in step 3904. Here, the troubleshooter may be already involved in the project or may be outside of the project. Once the troubleshooting resource is assigned, the troubleshooter attempts to fix the problem file. If able to fix the problem file as queried in step 3905, the troubleshooter uploads the repaired file and the program manager continues with approval in step 3906. If the troubleshooter is unable to fix the problem file, the program manager may return the problem file to the resource (or at least an alert that the file has uncorrectable errors) and request that the resource recreate the file (including retranslating the file or reediting the file as dependent on the role of the resource who created the file).

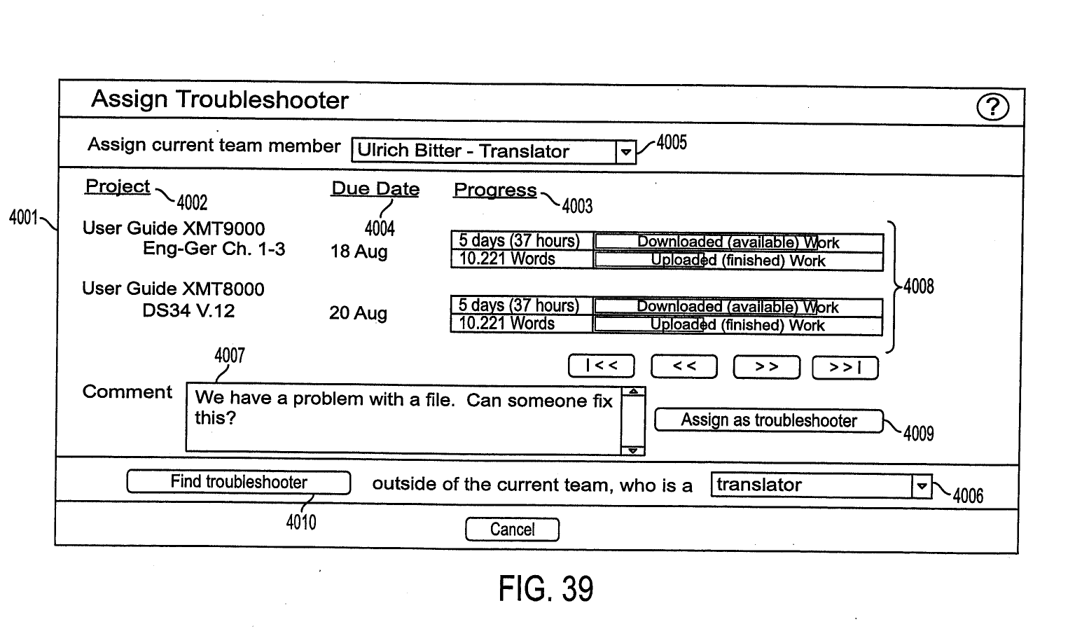

FIG. 39 shows a troubleshooter assignment interface for a program manager in accordance with embodiments of the present invention. As mentioned in step 3904 above, a program manager may attempt to assign a troubleshooter to a project. To do so, a program manager is provided with a user interface 4001 for designating a troubleshooter. The program manager may select from current team members working on a project from menu 4005. Once a team member has been selected, the program manager may review the projects the resource currently has 4002 as well as their due dates 4004 and the resource's progress 4003 on each (shown for example textually and graphically in display portion 4008). A program manager may add a comment to be sent to the resource in window 4007 and assign the resource to as a troubleshooter through selecting the “assign as troubleshooter” button 4009. Finally, if no troubleshooter can be designated on the current project team, the program manager may attempt to search for a troubleshooter with a certain role through activation of button “find troubleshooter” 4010 and selection of a role type as provided in interface 4006.

We claim:

1. A system for providing workflow monitoring system comprising:
a program manager that divides a project into subprojects and that assigns resources to the subprojects, said program manager having predefined templates by which to model the project.

2. The system according to claim 1, wherein the resources include translators.

3. The system according to claim 1, wherein the resources include editors.

4. The system according to claim 1, wherein the program manager resides on a first computer and
wherein said subprojects are handled on said first computer.

5. The system according to claim 1, wherein the program manager resides on a first computer and
wherein said subprojects are handled on a second computer.

6. A process for assigning resources to a translation project comprising the steps of:
receiving an electronic version of a file to be translated;
determining a characteristic the electronic version of the file to be translated;
obtaining a translation rate;
estimating a time for translating based on the characteristic and the translation rate; and
assigning resources to the project based on the estimate of time for translating.

7. The process according to claim 6, wherein the characteristic includes the size of the electronic file.

8. The process according to claim 6, wherein the characteristic includes the number of words in the electronic file.

9. The process for assigning resources according to claim 6, further comprising the steps of:
inspecting the file to be translated against a translation memory, said inspecting step resulting in an analysis of matches between content of said file and said memory, said matches falling into at least two ranges;
obtaining a translation rate for the matches obtained by said analysis;
determining an estimated time for range;
calculating the time for translating each range;
summing the times of said calculating step;
assigning resources based on the result of said summing step.

10. A user interface for a project manager comprising:
a first display portion showing a project name;
a second display portion showing at least one subproject associated with the project;
a third display portion showing at least one resource assigned to said subproject for working on said subproject; and,
a fourth display portion displaying the status of the work of said resource on said subproject.

11. The user interface according to claim 10, wherein said fourth display includes at least one of a graphical representation and a textual representation of the status of said work.
